(19) United States
(12) Patent Application Publication
(10) Pub. No.: US 2023/0087020 A1
(43) Pub. Date: Mar. 23, 2023

(54) COMPOSITION FOR EXTENDING VIABLE PRESERVATION AND SHELF-LIFE OF ORGANS AND TISSUES

(71) Applicants: University of Florida Research Foundation, Incorporated, Gainesville, FL (US); University of Notre Dame du Lac, South Bend, IN (US)

(72) Inventors: Keith L. March, Gainesville, FL (US); Dmitry Olegovich Traktuev, Gainesville, FL (US); Pinar Zorlutuna, Notre Dame, IN (US); Bradley Ellis, Notre Dame, IN (US)

(73) Assignees: University of Florida Research Foundation, Incorporated, Gainesville, FL (US); University of Notre Dame du Lac, South Bend, IN (US)

(21) Appl. No.: 17/909,067

(22) PCT Filed: Mar. 10, 2021
(86) PCT No.: PCT/US2021/021718

§ 371 Date: Sep. 2, 2022

Related U.S. Application Data
(60) Provisional application No. 62/987,731, filed on Mar. 10, 2020.

(51) Int. Cl. A01N 1/02

(52) U.S. Cl. CPC A01N 1/0226

(57) ABSTRACT

Provided herein are compositions and methods related to extending viable preservation of organs and tissues. The compositions comprise superoxide dismutase, catalase, vitamin E, and glutathione, and optionally, a preservation solution (e.g., University of Wisconsin solution). Also provided are methods of preserving the contractile function of a contractile tissue, as well as kits comprising the compositions described herein.

### RELATED APPLICATION

The present application claims priority under 35 U.S.C. § 119(e) to U.S. provisional patent application, U.S. Ser. No. 62/987,731, filed Mar. 10, 2020, which is incorporated herein by reference.

### GOVERNMENT SUPPORT

This invention was made with government support under Grant No. 7101BX003888-02 awarded by US Department of Veteran Affairs Gainesville. The government has certain rights in the invention.

### BACKGROUND

Organ transplantation is a key life-saving procedure for patients with failed or injured organs. In the United States alone, over 36,500 organ transplants were performed in 2018, according to the United Network for Organ Sharing (UNOS). However, use of this curative treatment, e.g., heart transplantation, is limited by a severe shortage in donor organ supply. ^{1,2} While there are around 50,000 patients with severe heart failure that are candidates for cardiac transplantation, only around 3000 cardiac transplants are conducted yearly in the USA. Due to a progressively aging population, the number of patients on the waiting list for heart transplantation is constantly growing, while the supply of acceptable donor hearts has not markedly increased, resulting in an approximate 20% yearly mortality among patients waiting for heart transplantation.¹⁻³ There is an urgent need to develop effective approaches to increase the pool of donor organs and their actual acceptance for transplantation.

### SUMMARY

Described herein are compositions and methods relating to preserving an organ or tissue. For example, the compositions and methods described herein may be used to preserve a donor heart. Currently, post-transplant cardiac function predictably deteriorates in relation to the total ischemic time during transport, and a practical threshold of four hours of ischemic time which has been established for acceptable clinical outcomes causes a significant number of available hearts to be rejected for transplant. Described herein are approaches that ameliorate post-transport organ and tissue damage, thereby expanding the pool of acceptable transplant organs and tissues.

In one aspect, the disclosure provides a composition comprising superoxide dismutase, catalase, vitamin E, and glutathione. In some embodiments, the superoxide dismutase is Cu/Zn superoxide dismutase (SOD1), manganese-dependent superoxide dismutase (SOD2), extracellular superoxide dismutase (SOD3), cell surface superoxide dismutase (SOD4), or a combination thereof. In some embodiments the glutathione is reduced. In some embodiments, the vitamin E is DL-alpha tocopherol acetate, DL alpha-tocopherol, or a combination thereof.

In some embodiments, the composition further comprises one or more of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

In some embodiments, the vitamin A is vitamin A acetate. In some embodiments, the BSA is Fraction V, fatty acid-free BSA. In some embodiments, composition comprises one or more salt forms of certain components; that is, the ethanolamine is a salt thereof, e.g., ethanolamine HCl; the L-carnitine is a salt thereof, e.g., L-carnitine HCl; the linoleic acid is a salt thereof, e.g., linoleate; the linolenic acid is a salt thereof, e.g., linolenate; and/or the putrescine is a salt thereof, e.g., putrescine 2HCl.

In some embodiments, the composition further comprises a preservation solution. The preservation may comprise at least two of the following: sodium, potassium, magnesium, calcium, chloride, phosphate, sulfate, bicarbonate, glucose, histidine, tryptophan, glutamic acid, α-ketoglutarate, lactobionic acid, mannitol, hydroxyethyl starch, raffinose, adenosine, allopurinol, and glutathione. In one embodiment, the preservation solution comprises pentafraction, lactone, potassium phosphate monobasic, magnesium sulfate heptahydrate, raffinose pentahydrate, adenosine, allopurinol, glutathione, and potassium hydroxide.

In one embodiment, the preservation solution comprises University of Wisconsin solution (Viaspan™; Belzer UW® Cold Storage Solution, SPS-1), histidine-tryptophan-ketoglutarate (HTK; CUSTODIOL® HTK solution) solution, CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1®), Marshall citrate solution, or a combination thereof.

In some aspects, the composition comprises at least one of the preservation solutions and B-27™ supplement (Gibco™), for example, University of Wisconsin solution and B27™ supplement. In other embodiments, the composition comprises at least one of the preservation solutions and NS21 (Sigma-Aldrich), GS21 (GlobalStem), Gem21 NeuroPlex™ serum-free supplement (GeminiBio), Prime-XV IS21 supplement (Irvine Scientific/FujiFilm), or any combination thereof.

In some embodiments, the composition is sterile, for example, the composition is Current Good Manufacturing Practice (cGMP)-compliant.

A further aspect of the disclosure includes a method of preserving an organ, the method comprising contacting the organ or tissue with any one of the compositions described herein. Aspects of the disclosure also provide the use of any one of the compositions described herein for preserving an organ or tissue, wherein the composition is contacted with the organ or tissue.

In some embodiments, the step of contacting comprises immersing, infusing, flushing, or perfusing the tissue or organ with any one of the compositions described herein. In some embodiments, preserving the organ or tissue comprises flushing and immersing the organ or tissue in a preservation solution and then maintaining or storing the organ or tissue in any one of the compositions described herein.

In some embodiments, the organ or tissue is contacted with the composition for a minimum of 10 seconds to a maximum of 14 days. In some embodiments, the organ or tissue is contacted with the composition for 30 minutes to 50 hours. In some embodiments, the organ or tissue is contacted with the composition for 4-8 hours.

In some embodiments, the organ or tissue is contacted with the composition at a temperature of 0° C. to 8° C. In some embodiments, the organ or tissue is contacted with the composition at a temperature of 4° C.

In some embodiments, the organ or tissue is contacted with the composition at a temperature of 13° C. to 17° C. In some embodiments, the organ or tissue is contacted with the composition at a temperature of 15° C.

In some embodiments, organ or tissue is contacted with the composition at a temperature of 30° C. to 38° C. In some embodiments, the organ or tissue is contacted with the composition at a temperature of 37° C.

In some embodiments, the method further comprises transplanting the preserved organ or tissue into a subject in need thereof. Likewise, any one of the compositions described herein, in some embodiments, may be useful for treating a subject in need of an organ or tissue transplant, for example, by transplanting an organ or tissue preserved with any of the compositions described herein into the subject.

In some embodiments, the organ is selected from the group consisting of heart, kidney, liver, lungs, pancreas, stomach, intestine, uterus, thymus, hand, foot, arm, head, hair follicle, skin, and face. In some embodiments, the tissue is selected from the group consisting of cornea, bone, tendon, muscle, pancreatic islet cells, heart valve, hematopoietic stem cells, mesenchymal stem/stromal cells, keratinocytes and other epithelial cells, nerve, and vascular tissue (e.g., vein, artery). In some embodiments, the organ is a heart. In some embodiments, the organ is a lung. In some embodiments, the organ is a kidney.

In some embodiments, the subject is a bird, fish, reptile, amphibian, human, or non-human mammal, such as a primate, cow, bull, pig, horse, sheep, goat, cat, or dog. In one embodiment, the subject is a human.

An additional aspect of the disclosure provides a method of prolonging organ or tissue survival ex vivo, the method comprising contacting the organ or tissue with any one of the compositions provided herein. A further aspect of the disclosure provides the use of any one of the compositions provided herein for prolonging organ or tissue survival ex vivo, wherein the organ or tissue is contacted with any one of the compositions provided herein.

Another aspect of the disclosure includes a method of increasing transplant success (e.g., improving survival rates), the method comprising contracting an organ or tissue to be transplanted with any one of the compositions provided herein. In some aspects, the disclosure provides the use of the any one of the compositions provided herein for increasing transplant success (e.g., improving survival rates), wherein an organ or a tissue for transplant is contacted with any one of the compositions provided herein.

A further aspect of the disclosure provides a method of preserving contractile function in a contractile tissue, the method comprising contacting the contractile tissue with any one of the compositions provided herein. An additional aspect of disclosure provides the use of any one of the compositions provided herein for preserving contractile function in a contractile tissue, wherein the contractile tissue is contacted with any one of the compositions provided herein.

In some embodiments, the contractile tissue comprises cardiac muscle, smooth muscle, skeletal muscle, or a combination thereof. In one embodiment, the contractile tissue is heart tissue and, for example, comprises cardiomyocytes.

In some embodiments, the contractile tissue is preserved in vitro, in situ, or ex vivo.

In another aspect, the disclosure provides a kit comprising any one of the compositions described herein. For example, the kit may comprise a first container comprising a preservation solution, and a second container comprising superoxide dismutase, catalase, vitamin E, and glutathione. In other embodiments, the second container further comprises at least one of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3). In some embodiments, the kit comprises instructions for using the kit. In one embodiment, the kit further comprises a syringe. In one embodiment, the kit further comprises a catheter.

The details of certain embodiments of the invention are set forth in the Detailed Description of Certain Embodiments, as described below. Other features, objects, and advantages of the invention will be apparent from the Definitions, Examples, Figures, and Claims.

### BRIEF DESCRIPTION OF THE DRAWINGS

The accompanying drawings, which constitute a part of this specification, illustrate several embodiments of the invention and together with the description, serve to explain the principles of the invention.

FIGS. 1A-1B. Analysis of rat heart function. Hearts were harvested and affixed on a Langendorff apparatus, and baseline heart rate and ejection fraction were recorded (20 min), followed by organ perfusion with University of Wisconsin solution with or without B27 and cold storage for 5 hours. Hearts were then reattached on the apparatus and functional data was collected for 50 min. The rate pressure product's change from baseline in each group is presented in FIG. 1A, and the percent change is shown in FIG. 1B. ** p≤0.01, * p≤0.05, ns, no significance.

FIGS. 2A-2C. B27 promotes human iPS-derived cardiomyocyte (iCM) recovery post UW treatment. FIG. 2A illustrates the effects of B27 supplement on recovery of iCM beating rate. iCMs were exposed to UW at 4° C. for 4 hours, followed by incubation in RPMI media alone or with supplements (adipose-derived stem/stromal cells, ASC-S, or B27) at 37° C. for 24 hours. Time “0” represents the moment when UW solution was exchanged to RPMI ±supplements. FIGS. 2B-2C indicate the prevalence of cleaved caspase-3+iCM (FIG. 2B) and beating velocity of iCMs (FIG. 2C) evaluated after cells were exposed to UW for 4 hours, followed by incubation in RPMI ±supplements (ASC-CM or B27) for 24 hours. For all graphs: n=6; *p≤0.05, **p≤0.01.

FIG. 3. A graph depicting rat maximal heart function, measured as the rate pressure product's percent recovery from baseline after five hours of storage in the indicated media. **p≤0.01, ***p≤0.001.

FIG. 4. A graph depicting rat maximal heart function, measured as the rate pressure product's percent recovery from baseline after five hours of storage (in UW solution) or seven hours of storage in the combination media (either UW with B27 or UW with 3×B27). p≤0.05.

FIG. 5. A graph depicting the percent recovery of the initial beat rate in human iCM over time following four hours of culture in UW solution alone or supplemented with B27.

FIG. 6. A graph showing average peak beating velocity of human iCM. The beating velocity of the iCM was evaluated in the control cells or cells after exposure to UW±B27 at 4° C. for 4 hours, followed by incubation in iCM complete (full) culture media for 24 hours. ***p≤0.001.

FIGS. 7A-7D. Aspects of mitochondrial function measured in rats infused with ice cold UW cardioplegic solution alone or augmented with either B27 or B22 and stored in the same solution for five hours at 4° C. Oxygen consumption (FIG. 7A), oxidative phosphorylation (FIG. 7B), hydrogen peroxide generation (FIG. 7C), and electron leak (FIG. 7D) were measured. Octanoyl-Carnitine and Malate were used as substrates.

FIGS. 8A-8D. Aspects of mitochondrial function measured in rat hearts infused with ice cold UW cardioplegic solution alone or augmented with either B27 or B22 and stored in the same solution for five hours at 4° C. Oxygen consumption (FIG. 8A), oxidative phosphorylation (FIG. 8B), hydrogen peroxide generation (FIG. 8C), and electron leak (FIG. 8D) were measured. Pyruvate and Malate were used as substrates.

FIGS. 9A-9B. Aspects of mitochondrial function measured in rat hearts infused with ice cold UW cardioplegic solution alone or augmented with either B27 or B22, and then stored in the same solution for five hours at 4° C. After storage, hearts were attached to Langendorff apparatus and perfused with oxygenated Krebs-Henseleit buffer for one hour and then subjected to mitochondrial function assessment in isolated cardiomyocyte bundles. FIG. 9A shows the oxygen consumption and respiratory conductance when Pyruvate and Malate were used as substrates. FIG. 9B shows the oxygen consumption and respiratory conductance when Octanoyl-Carnitine and Malate were used as substrates.

### DEFINITIONS

The term “composition”, as used herein, refers to a solution comprising a superoxide dismutase, catalase, vitamin E, glutathione, or a combination thereof. In some embodiments, the superoxide dismutase is Cu/Zn superoxide dismutase (SOD1), manganese-dependent superoxide dismutase (SOD2), extracellular superoxide dismutase (SOD3), cell surface superoxide dismutase (SOD4), or a combination thereof. In some embodiments, the superoxide dismutase is a small molecule having superoxide dismutase activity. In some embodiments the glutathione is reduced. In some embodiments, the vitamin E is DL-alpha tocopherol acetate, DL alpha-tocopherol, or a combination thereof. In some embodiments, the composition further comprises one or more of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3). In some embodiments, the supplemental solution is B-27™ (Gibco™), NS21 (Sigma-Aldrich), GS21 (GlobalStem), Gem21 NeuroPlex™ serum-free supplement (GeminiBio), Prime-XV IS21 supplement (Irvine Scientific/FujiFilm), or any combination thereof.

The term “preservation solution” refers to a solution typically used for organ and/or tissue transport or transplant. Such solutions are known in the art and University of Wisconsin solution (Viaspan™; Belzer UW® Cold Storage Solution, SPS-1), histidine-tryptophan-ketoglutarate (HTK) solution (CUSTODIOL® solution), CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1), and Marshall citrate solution. In embodiments, the preservation solution comprises at least two of the following: sodium, potassium, magnesium, calcium, chloride, phosphate, sulfate, biocarbonate, glucose, histidine, tryptophan, glutamic acid, α-ketoglutarate, lactobionic acid, mannitol, hydroxyethyl starch, raffinose, adenosine, allopurinol, and glutathione.

In some embodiments, the preservation solution is supplemented with one or more commercially available supplemental solutions. “Supplemental solutions” are serum-free cell culture supplements, generally used for growth and viability in culture. Examples of supplemental solutions include B-27™ (Gibco™), NS21 supplement (Sigma-Aldrich), GS21™ supplement (GlobalStem), Gem21 NEUROPLEX™ serum-free supplement (GeminiBio), and Prime-XV IS21 supplement (Irvine Scientific/FujiFilm).

A composition is “sterile” if it is medically acceptable, that is, it has a bioburden wherein the probability of having one living microorganism (e.g., colony forming unit, CFU) in the composition is 1/1,000,000 or less.

A composition is “current good manufacturing practice (cGMP)-compliant” if it would pass all of the cGMP regulations set forth by the FDA. Likewise, a composition described herein may be “good manufacturing practice-compliant” (GMP-compliant), meaning that it would meet the requirements of the European Medicines Agency (EMA). A composition described herein may also be “Japanese Good Manufacturing Practice-compliant,” referring to a composition that would comply with the regulations set forth by the Japanese Pharmaceuticals and Medical Device Agency.

“Preserving” as used herein, refers to a process of maintaining an organ or tissues such that they can be successfully transplanted into a donor subject or such that they possess the characteristics of living organs or tissues (e.g., maintain or increase the initial level of function). “Preservation time” refers to the amount of time that an organ or tissue is between its extraction from a donor and its transplantation in a recipient. In some embodiments, the preservation time is the “shelf life,” that is, the time after extraction and before transplantation when an organ or tissue is stored.

As used herein, “transplant,” refers to the transfer of an organ or tissue from a donor to a recipient for the purpose of replacing the recipient's own damaged, diseased, or absent organ or tissue. The donor refers to a subject from whom the organ or tissue to be transplanted is derived. The donor may be dead or alive at the time of donation. In some embodiments, the donor is human. The recipient is a subject who will receive the donor's organ or tissue.

An “organ” refers to a differentiated, self-contained structure (e.g., group of tissues) that performs a specific function or group of functions in an organism. As described herein, organs may be contacted with any of the compositions described herein prior to and/or during transplantation or for preservation. Exemplary organs that may be transplanted include heart, kidney, liver, lungs, pancreas, stomach, intestine, uterus, thymus, hand, foot, arm, eye, head, hair follicle, and face.

A “tissue” refers to a group of similar cells from the same origin and their extracellular matrix. The cells carry out a specific function together, and together, form organs. Examples of tissues that may be transplanted include cornea, lens, bone, bone marrow, tendon, skin, muscle, connective tissue, cartilage, heart valve, hepatocytes, pancreatic islet cells, hematopoietic stem cells, mesenchymal stem/stromal cells, keratinocytes and other epithelial cells, nerves, and vascular tissue (e.g., vein, artery).

An “effective amount” of a compound described herein refers to an amount sufficient to prolong the viability or preservation time of an organ or tissue, especially ex vivo or in situ. An effective amount of a composition described herein may vary depending on such factors as the organ or tissue being transplanted, the desired biological endpoint, the mode of administration, and/or the age and health of the organ or tissue to be preserved/transplanted.

As used herein, “ex vivo” refers to a condition that takes place outside an organism (e.g., a subject). For example, transplant organs or tissues may be preserved ex vivo after extraction from a donor subject.

As used herein, “in situ” refers to organs or tissues that are still part of an organism (e.g., a subject). For example, organs and tissues may be preserved in situ prior to extraction from a donor subject.

A “subject,” as used herein, refers to a human (i.e., male or female of any age group, e.g., pediatric subject (e.g., infant, child, or adolescent) or adult subject (e.g., young adult, middle-aged adult, or senior adult)) or non-human animal. In certain embodiments, the non-human animal is a mammal (e.g., primate (e.g., cynomolgus monkey or rhesus monkey), commercially relevant mammal (e.g., cattle, pig, horse, sheep, goat, cat, or dog), or bird (e.g., commercially relevant bird, such as chicken, duck, goose, or turkey)). In certain embodiments, the non-human animal is a fish, reptile, or amphibian. The non-human animal may be a male or female at any stage of development. The non-human animal may be a transgenic animal or genetically engineered animal. The subject may be a donor (e.g., a subject having the organ or tissue to be preserved and/or transplanted) or the subject may be a recipient (e.g., a subject in which the donated organ or tissue will be transplanted). The donor may be alive or deceased.

### DETAILED DESCRIPTION OF CERTAIN EMBODIMENTS

The lack of viable organs for transplantation is a global challenge. Even when tissues or organs are available from donors, they may not be viable or usable, for example, because they are functionally compromised or will become functionally compromised during transport. The methods and compositions provided herein lengthen the amount of time that an organ or tissue is viable can therefore can be used for transplantation, thereby expanding the number of usable transplant organs and tissues.

Provided herein are compositions useful for the preservation of an organ or tissue comprising at least a superoxide dismutase, catalase, vitamin E, and glutathione. In some embodiments, the composition further comprises one or more of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3). In some embodiments, the compositions provided herein further comprise a preservation solution (e.g., University of Wisconsin solution (Viaspan™; Belzer UW® Cold Storage Solution, SPS-1), histidine-tryptophan-ketoglutarate (HTK) solution (CUSTODIOL® solution), CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1), Marshall citrate solution, or a combination thereof).

The disclosure also provides methods of preserving an organ or tissue for transplantation using any of the compositions described herein. Also provided are methods of prolonging organ or tissue survival ex vivo (e.g., the shelf-life of an organ or tissue) using the compositions described herein. The compositions described herein may also be used to preserve or prolong the viability of cells, for example, to preserve contractile function in contractile cells or tissues. The disclosure further provides kits comprising the compositions described herein.

The methods and compositions provided herein address some of the major challenges associated with organ and tissue viability for transplantation. For example, the heart is a particularly challenging organ with respect to the maintenance of viability during storage/preservation, due to its high metabolic requirements and its consequently limited tolerance to pre-transplant ischemic damage. During organ procurement, cardiac arrest is immediately induced by the introduction of cold cardioplegia solution following aortic clamping in order to retard cardiac metabolism. However, cardiac metabolic reactions continue, so that the period of cardioplegia is accompanied by a spectrum of alterations which predispose the heart to injury upon reperfusion.^{4,5} The ischemia/reperfusion injury in conjunction with implantation adversely affects the recovery of cardiac function in recipients.

The ischemic time of the donor heart is recognized as a significant negative contributor to transplantation outcomes and increases the risk of both acute and delayed graft dysfunction. While short ischemic periods during cold storage are reasonably well-tolerated, progressive functional deterioration occurs when the cold ischemic period extends beyond 4 hours, and is particularly severe when storage time is greater than 6 hours.^{6,7} Therefore, mitigation of ischemia/reperfusion injury during and following organ storage/transportation will improve donor organ preservation, translating into an increased acceptable transport time for these organs. An increase in transport time will in turn increase the geographic area within which each donor organ is available to patients in need.

### Compositions

As demonstrated in the Examples, it was found that supplementing University of Wisconsin (UW) solution with B-27™ (Gibco™) preserved heart function and promoted cardiomyocyte recovery after UW treatment. Without wishing to be bound by theory, it is thought that the addition of a composition comprising certain components of B-27™ (e.g., the anti-oxidants, superoxide dismutase, catalase, vitamin E, and glutathione) that reduce injury caused by reactive oxygen species, can be used to preserve organs and tissues for longer periods of time than compositions without such components. Accordingly, the methods and compositions described herein relate to composition comprising superoxide dismutase, catalase, vitamin E, glutathione, or combinations thereof.

In some embodiments, the superoxide dismutase is Cu/Zn superoxide dismutase (SOD1), manganese-dependent superoxide dismutase (SOD2), extracellular superoxide dismutase (SOD3), cell surface superoxide dismutase (SOD4), or a combination thereof. In some embodiments the glutathione is reduced. In some embodiments, the vitamin E is DL-alpha tocopherol acetate, DL alpha-tocopherol, or a combination thereof.

In some embodiments, the composition further comprises one or more of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

In some embodiments, the vitamin A is vitamin A acetate. In some embodiments, the BSA is Fraction V, fatty acid-free BSA. In some embodiments, composition comprises one or more salt forms of certain components; that is, the ethanolamine is a salt thereof, e.g., ethanolamine HCl; the L-carnitine is a salt thereof, e.g., L-carnitine HCl; the linoleic acid is a salt thereof, e.g., linoleate; the linolenic acid is a salt thereof, e.g., linolenate; and/or the putrescine is a salt thereof, e.g., putrescine 2HCl.

The composition may further comprise a preservation solution. As used herein, a “preservation solution” is a solution typically used for organ and/or tissue transplant/transport. In some embodiments, the preservation solution comprises at least 2, 3, 4, 5, 6, 7, 8, 9, or 10 of the following: sodium, potassium, magnesium, calcium, chloride, phosphate, sulfate, biocarbonate, glucose, histidine, tryptophan, glutamic acid, α-ketoglutarate, lactobionic acid, mannitol, hydroxyethyl starch, raffinose, adenosine, allopurinol, and glutathione. In one embodiment, the preservation solution comprises pentafraction, lactone, potassium phosphate monobasic, magnesium sulfate heptahydrate, raffinose pentahydrate, adenosine, allopurinol, glutathione, and potassium hydroxide.

Commercially available examples of preservation solutions include, but are not limited to University of Wisconsin solution (“UW solution”; also known as Viaspan or CoStolSol®; Southard et al., Transplant Rev. October 1993, 7(4): 176-190; Southard et al., Annu Rev Med. 1995; 46(1): 235-247), histidine-tryptophan-ketoglutarate (HTK) solution (e.g., CUSTODIOL® HTK Solution; Ringe et al., Transplant Proc. 2005; 37:316-319 and Pokorny et al., Transpl Int. 2004; 17:256-260), CELSIOR® solution (Wittwer et al., Eur J Cardiothorac Surg. 1999; 15(5):667-671; Struber et al., Transpl. 1999; 67(7):s90), Kyoto University solution (Chen et al., Yonsei Med J. 2004; 45(6): 1107-1114; Omasa et al., Annals of Thor Surg. 2004; 77(1): 338-339), Institut Georges Lopez, France (IGL-1) solution (Wiederkehr et al., Transplant Proc. 2014; 46(6): 1809-1811), Collins solution (e.g., Euro-Collins Solution; Toshima et al., J Thorac Cardiovasc Surg. 1992; 104(6):1572-1581; Olthoff et al., Clin Transpl. 1990), STEEN solution™ (U.S. Pat. No. 7,255,983; Carnevale et al., Oxid Med Cell Longev. 2014; and Marshall citrate solution (hyperosmolar citrate; Marshall et al., Med J Aust. 1977; 2(11):353-356). In some embodiments, the preservation solution is a modified version of a commercially available preservation solution. In some embodiments, the preservation solution is UW solution. Other preservation solutions are known in the art and are readily ascertainable by one of ordinary skill in the art.

As noted above, the composition comprises anti-oxidants, such as a superoxide dismutase, catalase, vitamin E, and glutathione.

Superoxide dismutase (SOD) is an anti-oxidant enzyme that catalyzes the dismutation of the superoxide radical into molecular oxygen or hydrogen peroxide. There are four main types of SOD, each of which depends on the protein fold and the metal co-factor. Cu/Zn SOD (SOD1), is most commonly used by eukaryotes and is typically found in the cytosol of eukaryotic cells. SOD1 binds both copper and zinc. Manganese-dependent superoxide dismutase (SOD2), is an enzyme encoding a mitochondrial protein that forms a homotetramer that binds manganese and superoxide byproduces of oxidative phosphorylation, converting them to hydrogen peroxide and diatomic oxygen. Extracellular SOD (SOD3) binds nickel and is of prokaryote origin. Cell surface superoxide dismutase (SOD4) is a copper/zinc dismutase found on the cell surface. In the compositions provided herein, the superoxide dismutase, in some embodiments, is Cu/Zn superoxide dismutase (SOD1), manganese-dependent superoxide dismutase (SOD2), extracellular superoxide dismutase (SOD3), cell surface superoxide dismutase (SOD4), or a combination thereof. In some embodiments, the SOD1, SOD2, and/or SOD3 are human enzymes, e.g., those given by NCBI reference sequence numbers NP_000445.1, NP_000627.2, and NP_003093.2, respectively. In one embodiment, the SOD4 is a Candida albicans enzyme, e.g., that given by NCBI reference sequence number XP_719509.1 The SOD1 enzyme may be encoded by the NCBI reference sequence NM_000454.5. The SOD2 enzyme may be encoded by the NCBI reference sequence NM_000636.4. The SOD3 enzyme may be encoded by the NCBI reference sequence NM_003102.4. The SOD4 enzyme may be encoded by the NCBI reference sequence XM_714416.1. In some embodiments, the SOD1, SOD2, SOD3, and/or SOD4 in the compositions described herein are at least 70%, 75%, 80%, 85%, 90%, 91%, 92%, 93%, 94%, 95%, 96%, 97%, 98%, 99%, or 100% identical to the SOD1, SOD2, SOD3, or SOD4 sequences (protein or DNA) referenced herein.

In some embodiments, the SOD may be a small molecule superoxide dismutase mimetic, such as a manganese cyclic polyamine (e.g., M40403), a nitroxide (e.g., TEMPOL), a manganese salen (e.g, EUK-8), a MnPLED derivative (e.g., MnDPDP), or a manganese porphyrin (e.g., MnBuOE) (Bonetta, Chemistry. 2018 Apr. 6;24(20):5032-5041). Other examples of such molecules include manganese (III) mesotetrakis (N-ethylpyridinium-2-yl) porphyrin (MnTE-2-PyP^{5±}) (AEOL10113; Vujaskovic et al., Free Radic Biol Med. 2002 Sep. 15;33(6):857-63) and avasopasem manganese (GC4419; Anderson et al., IJROBP, 2018 Feb. 1;100(2):427-435).

The composition, in some embodiments, may comprise catalase. Catalase is an anti-oxidant enzyme found in most organisms exposed to oxygen. It catalyzes the decomposition of hydrogen peroxide to water and oxygen (e.g., when SOD dismutates superoxide into hydrogen peroxide, catalase decomposes the hydrogen peroxide to water and oxygen). Its role in the cell is to protect the cell from oxidative damage from reactive oxygen species (ROS). The enzyme has one of the highest turnover rates of any enzyme; one catalase molecule is capable of converting millions of hydrogen peroxide molecules to water and oxygen every second. In some embodiments, the catalase enzyme is a human enzyme; e.g., that given by NCBI reference sequence number NP_001743.1, or encoded by the NCBI reference sequence NM_001752.4. In some embodiments, the catalase in the compositions described herein is at least 70%, 75%, 80%, 85%, 90%, 91%, 92%, 93%, 94%, 95%, 96%, 97%, 98%, 99%, or 100% identical to the catalase sequences (protein or DNA) referenced herein.

In some embodiments, the supplemental solution further comprises glutathione. In certain embodiments, the supplemental solution comprises reduced glutathione. Glutathione is an anti-oxidant and therefore is capable of preventing damage from ROS in its reduced form.

In some embodiments, the composition comprises vitamin E. Vitamin E encompasses eight fat soluble compounds: four tocopheronols and four tocotrienols. Vitamin E acts as a radical scavenger and adds a hydrogen to free radicals. In any one of the compositions described herein, the vitamin E is alpha tocopherol, beta tocopherol, gamma tocopherol, delta tocopherol, alpha tocotrienol, beta tocotrienol, gamma tocotrienol, or delta tocotrienol. In some embodiments, the vitamin E is DL-alpha tocopherol acetate, DL alpha-tocopherol, or a combination of DL-alpha tocopherol acetate and DL alpha-tocopherol.

The compositions described herein, in some embodiments, comprise superoxide dismutase, catalase, vitamin E, and glutathione. In some embodiments, the four components (e.g., a superoxide dismutase, catalase, vitamin E, and glutathione) are present in equal parts. In other embodiments, the four components are not present in equal parts; for example, a composition comprises 1 U/mL to 100 U/mL SOD, 12.50 U/mL to 12500 U/mL catalase, 0.1 μg/mL to 100 μg/mL vitamin E, and 1 μg/mL to 100 μg/mL glutathione.

In some embodiments, the quantity of SOD (e.g., SOD1, SOD2, SOD3, SOD4, or a combination thereof) in the composition is 1 U/mL, 2 U/mL, 3 U/mL, 4 U/mL, 5 U/mL, 6 U/mL, 7 U/mL, 8 U/mL, 9 U/mL, 10 U/mL, 15 U/mL, 20 U/mL, 25 U/mL, 30 U/mL, 35 U/mL, 40 U/mL, 45 U/mL, 50 U/mL, 55 U/mL, 60 U/mL, 65 U/mL, 70 U/mL, 75 U/mL, 80 U/mL, 85 U/mL, 90 U/mL, 95 U/mL, or 100 U/mL or more. In some embodiments, the amount of SOD (e.g., SOD1, SOD2, SOD3, SOD4, or a combination thereof) in the composition is 1 U/mL-5 U/mL, 1 U/mL-10 U/mL, 1 U/mL-15 U/mL, 1 U/mL-20 U/mL, 1 U/mL-25 U/mL, 1 U/mL-30 U/mL, 1 U/mL-35 U/mL, 1 U/mL-40 U/mL, 1 U/mL-45 U/mL, 1 U/mL-50 U/mL, 1 U/mL-55 U/mL, 1 U/mL-60 U/mL, 1 U/mL-65 U/mL, 1 U/mL-70 U/mL, 1 U/mL-75 U/mL, 1 U/mL-80 U/mL, 1 U/mL-85 U/mL, 1 U/mL-90 U/mL, 1 U/mL-95 U/mL, 1 U/mL-100 U/mL, 5 U/mL-10 U/mL, 5 U/mL-15 U/mL, 5 U/mL-20 U/mL, 5 U/mL-25 U/mL, 5 U/mL-30 U/mL, 5 U/mL-35 U/mL, 5 U/mL-40 U/mL, 5 U/mL-45 U/mL, 5 U/mL-50 U/mL, 5 U/mL-60 U/mL, 5 U/mL-70 U/mL, 5 U/mL-80 U/mL, 5 U/mL-90 U/mL, 5 U/mL-100 U/mL, 10 U/mL-15 U/mL, 10 U/mL-20 U/mL, 10 U/mL-25 U/mL, 10 U/mL-30 U/mL, 10 U/mL-35 U/mL, 10 U/mL-40 U/mL, 10 U/mL-45 U/mL,10 U/mL-50 U/mL, 10 U/mL-60 U/mL, 10 U/mL-70 U/mL, 10 U/mL-80 U/mL, 10 U/mL-90 U/mL, 10 U/mL-100 U/mL, 15 U/mL-20 U/mL, 15 U/mL-25 U/mL, 15 U/mL-30 U/mL, 15 U/mL-35 U/mL, 15 U/mL-40 U/mL, 15 U/mL-45 U/mL, 15 U/mL-50 U/mL, 15 U/mL-60 U/mL, 15 U/mL-70 U/mL, 15 U/mL-80 U/mL, 15 U/mL-90 U/mL, 15 U/mL-100 U/mL, 20 U/mL-25 U/mL, 20 U/mL-30 U/mL, 20 U/mL-35 U/mL, 20 U/mL-40 U/mL, 20 U/mL-45 U/mL, 20 U/mL-50 U/mL, 20 U/mL-60 U/mL, 20 U/mL-70 U/mL, 20 U/mL-80 U/mL, 20 U/mL-90 U/mL, 20 U/mL-100 U/mL, 25 U/mL-30 U/mL, 25 U/mL-35 U/mL, 25 U/mL-40 U/mL, 25 U/mL-45 U/mL, 25 U/mL-50 U/mL, 25 U/mL-60 U/mL, 25 U/mL-70 U/mL, 25 U/mL-80 U/mL, 25 U/mL-90 U/mL, 25 U/mL-100 U/mL, 30 U/mL-35 U/mL, 30 U/mL-40 U/mL, 30 U/mL-45 U/mL, 30 U/mL-50 U/mL, 30 U/mL-60 U/mL, 30 U/mL-70 U/mL, 30 U/mL-80 U/mL, 30 U/mL-90 U/mL, 30 U/mL-100 U/mL, 35 U/mL-40 U/mL, 35 U/mL-45 U/mL, 35 U/mL-50 U/mL, 35 U/mL-60 U/mL, 35 U/mL-70 U/mL, 35 U/mL-80 U/mL, 35 U/mL-90 U/mL, 35 U/mL-100 U/mL, 40 U/mL-45 U/mL, 40 U/mL-50 U/mL, 40 U/mL-60 U/mL, 40 U/mL-70 U/mL, 40 U/mL-80 U/mL, 40 U/mL-90 U/mL, 40 U/mL-100 U/mL, 45 U/mL-50 U/mL, 45 U/mL-60 U/mL, 45 U/mL-70 U/mL, 45 U/mL-80 U/mL, 45 U/mL-90 U/mL, 45 U/mL-100 U/mL, 50 U/mL-60 U/mL, 50 U/mL-70 U/mL, 50 U/mL-80 U/mL, 50 U/mL-90 U/mL, 50 U/mL-100 U/mL, 60 U/mL-70 U/mL, 60 U/mL-80 U/mL, 60 U/mL-90 U/mL, 60 U/mL-100 U/mL, 70 U/mL-80 U/mL, 70 U/mL-90 U/mL, 70 U/mL-100 U/mL, 80 U/mL-90 U/mL, 80 U/mL-100 U/mL, or 90 U/mL-100 U/mL.

In some embodiments, the quantity of catalase in the composition is 12.50 U/mL, 25 U/mL, 30 U/mL, 40 U/mL, 50 U/mL, 60 U/mL, 70 U/mL, 80 U/mL, 90 U/mL, 100 U/mL, 125 U/mL, 150 U/mL, 175 U/mL, 200 U/mL, 250 U/mL, 300 U/mL, 350 U/mL, 400 U/mL, 450 U/mL, 500 U/mL, 550 U/mL, 600 U/mL, 650 U/mL, 700 U/mL, 750 U/mL, 800 U/mL, 850 U/mL, 900 U/mL, 1000 U/mL, 1100 U/mL, 1200 U/mL, 1300 U/mL, 1400 U/mL, 1500 U/mL, 1600 U/mL, 1700 U/mL, 1800 U/mL, 1900 U/mL, 2000 U/mL, 2500 U/mL, 3000 U/mL, 3500 U/mL, 4000 U/mL, 4500 U/mL, 5000 U/mL, 5500 U/mL, 6000 U/mL, 6500 U/mL, 7000 U/mL, 7500 U/mL, 8000 U/mL, 8500 U/mL, 9000 U/mL, 9500 U/mL, 10000 U/mL, 11000 U/mL, 11500 U/mL, 12000 U/mL, 12500 U/mL, or more. In some embodiments, the amount of catalase in the composition is 12.50 U/mL-50 U/mL, 12.50 U/mL-75 U/mL, 12.50 U/mL-100 U/mL, 12.50 U/mL-150 U/mL, 12.50 U/mL-200 U/mL, 25 U/mL-50 U/mL, 25 U/mL-75 U/mL, 25 U/mL-100 U/mL, 25 U/mL-150 U/mL, 25 U/mL-200 U/mL, 50 U/mL-75 U/mL, 50 U/mL-100 U/mL, 50 U/mL-150 U/mL, 50 U/mL-200 U/mL, 100 U/mL-200 U/mL, 100 U/mL-300 U/mL, 100 U/mL-400 U/mL, 100 U/mL-500 U/mL, 100 U/mL-600 U/mL, 100 U/mL-700 U/mL, 100 U/mL-800 U/mL, 100 U/mL-900 U/mL, 100 U/mL-1000 U/mL, 500 U/mL-1000 U/mL, 500 U/mL-2500 U/mL, 500 U/mL-5000 U/mL, 1000 U/mL-1500 U/mL, 1000 U/mL-2000 U/mL, 1000 U/mL-5000 U/mL, 1000 U/mL-10000 U/mL, 1000 U/mL-12000 U/mL, 2500 U/mL-5000 U/mL, 2500 U/mL-7500 U/mL, 2500 U/mL-10000 U/mL, 2500 U/mL-12000 U/mL, 5000 U/mL-7500 U/mL, 5000 U/mL-10000 U/mL 5000 U/mL-12000 U/mL, 7500 U/mL-10000 U/mL, 7500 U/mL-12000 U/mL, 10000 U/mL-12000 U/mL, or 10000 U/mL-12500 U/mL.

In some embodiments, the concentration of vitamin E in the composition is 0.1 μg/mL, 0.2 μg/mL, 0.3 μg/mL, 0.4 μg/mL, 0.5 μg/mL, 0.6 μg/mL, 0.7 μg/mL, 0.8 μg/mL, 0.9 μg/mL, 1 μg/mL, 2 μg/mL, 3 μg/mL, 4 μg/mL, 5 μg/mL, 6 μg/mL, 7 μg/mL, 8 μg/mL, 9 μg/mL, 10 μg/mL, 15 μg/mL, 20 μg/mL, 25 μg/mL, 30 μg/mL, 35 μg/mL, 40 μg/mL, 45 μg/mL, 50 μg/mL, 55 μg/mL, 60 μg/mL, 65 μg/mL, 70 μg/mL, 75 μg/mL, 80 μg/mL, 85 μg/mL, 90 μg/mL, 95 μg/mL, or 100 μg/mL or more. In some embodiments, the concentration of vitamin E in the composition is 0.1 μg/mL-0.5 μg/mL, 0.1 μg/mL-1 μg/mL, 0.1 μg/mL-5 μg/mL, 0.1 μg/mL-10 μg/mL, 0.5 μg/mL-1 μg/mL, 0.5 μg/mL-5 μg/mL, 0.5 μg/mL-10 μg/mL, 1 μg/mL-5 μg/mL, 1 μg/mL-10 μg/mL, 1 μg/mL-15 μg/mL, 1 μg/mL-20 μg/mL, 1 μg/mL-25 μg/mL, 1 μg/mL-30 μg/mL, 1 μg/mL-35 μg/mL, 1 μg/mL-40 μg/mL, 1 μg/mL-45 μg/mL, 1 μg/mL-50 μg/mL, 1 μg/mL-55 μg/mL, 1 μg/mL-60 μg/mL, 1 μg/mL-65 μg/mL, 1 μg/mL-70 μg/mL, 1 μg/mL-75 μg/mL, 1 μg/mL-80 μg/mL, 1 μg/mL-85 μg/mL, 1 μg/mL-90 μg/mL, 1 μg/mL-95 μg/mL, 1 μg/mL-100 μg/mL, 5 μg/mL-10 μg/mL, 5 μg/mL-15 μg/mL, 5 μg/mL-20 μg/mL, 5 μg/mL-25 μg/mL, 5 μg/mL-30 μg/mL, 5 μg/mL-35 μg/mL, 5 μg/mL-40 μg/mL, 5 μg/mL-45 μg/mL, 5 μg/mL-50 μg/mL, 5 μg/mL-60 μg/mL, 5 μg/mL-70 μg/mL, 5 μg/mL-80 μg/mL, 5 μg/mL-90 μg/mL, 5 μg/mL-100 μg/mL, 10 μg/mL-15 μg/mL, 10 μg/mL-20 μg/mL, 10 μg/mL-25 μg/mL, 10 μg/mL-30 μg/mL, 10 μg/mL-35 μg/mL, 10 μg/mL-40 μg/mL, 10 μg/mL-45 μg/mL, 10 μg/mL-50 μg/mL, 10 μg/mL-60 μg/mL, 10 μg/mL-70 μg/mL, 10 μg/mL-80 μg/mL, 10 μg/mL-90 μg/mL, 10 μg/mL-100 μg/mL, 15 μg/mL-20 μg/mL, 15 μg/mL-25 μg/mL, 15 μg/mL-30 μg/mL, 15 μg/mL-35 μg/mL, 15 μg/mL-40 μg/mL, 15 μg/mL-45 μg/mL, 15 μg/mL-50 μg/mL, 15 μg/mL-60 μg/mL, 15 μg/mL-70 μg/mL, 15 μg/mL-80 μg/mL, 15 μg/mL-90 μg/mL, 15 μg/mL-100 μg/mL, 20 μg/mL-25 μg/mL, 20 μg/mL-30 μg/mL, 20 μg/mL-35 μg/mL, 20 μg/mL-40 μg/mL, 20 μg/mL-45 μg/mL, 20 μg/mL-50 μg/mL, 20 μg/mL-60 μg/mL, 20 μg/mL-70 μg/mL, 20 μg/mL-80 μg/mL, 20 μg/mL-90 μg/mL, 20 μg/mL-100 μg/mL, 25 μg/mL-30 μg/mL, 25 μg/mL-35 μg/mL, 25 μg/mL-40 μg/mL, 25 μg/mL-45 μg/mL, 25 μg/mL-50 μg/mL, 25 μg/mL-60 μg/mL, 25 μg/mL-70 μg/mL, 25 μg/mL-80 μg/mL, 25 μg/mL-90 μg/mL, 25 μg/mL-100 μg/mL, 30 μg/mL-35 μg/mL, 30 μg/mL-40 μg/mL, 30 μg/mL-45 μg/mL, 30 μg/mL-50 μg/mL, 30 μg/mL-60 μg/mL, 30 μg/mL-70 μg/mL, 30 μg/mL-80 μg/mL, 30 μg/mL-90 μg/mL, 30 μg/mL-100 μg/mL, 35 μg/mL-40 μg/mL, 35 μg/mL-45 μg/mL, 35 μg/mL-50 μg/mL, 35 μg/mL-60 μg/mL, 35 μg/mL-70 μg/mL, 35 μg/mL-80 μg/mL, 35 μg/mL-90 μg/mL, 35 μg/mL-100 μg/mL, 40 μg/mL-45 μg/mL, 40 μg/mL-50 μg/mL, 40 μg/mL-60 μg/mL, 40 μg/mL-70 μg/mL, 40 μg/mL-80 μg/mL, 40 μg/mL-90 μg/mL, 40 μg/mL-100 μg/mL, 45 μg/mL-50 μg/mL, 45 μg/mL-60 μg/mL, 45 μg/mL-70 μg/mL, 45 μg/mL-80 μg/mL, 45 μg/mL-90 μg/mL, 45 μg/mL-100 μg/mL, 50 μg/mL-60 μg/mL, 50 μg/mL-70 μg/mL, 50 μg/mL-80 μg/mL, 50 μg/mL-90 μg/mL, 50 μg/mL-100 μg/mL, 60 μg/mL-70 μg/mL, 60 μg/mL-80 μg/mL, 60 μg/mL-90 μg/mL, 60 μg/mL-100 μg/mL, 70 μg/mL-80 μg/mL, 70 μg/mL-90 μg/mL, 70 μg/mL-100 μg/mL, 80 μg/mL-90 μg/mL, 80 μg/mL-100 μg/mL, or 90 μg/mL-100 μg/mL.

In some embodiments, the concentration of glutathione in the composition is 1 μg/mL, 2 μg/mL, 3 μg/mL, 4 μg/mL, 5 μg/mL, 6 μg/mL, 7 μg/mL, 8 μg/mL, 9 μg/mL, 10 μg/mL, 15 μg/mL, 20 μg/mL, 25 μg/mL, 30 μg/mL, 35 μg/mL, 40 μg/mL, 45 μg/mL, 50 μg/mL, 55 μg/mL, 60 μg/mL, 65 μg/mL, 70 μg/mL, 75 μg/mL, 80 μg/mL, 85 μg/mL, 90 μg/mL, 95 μg/mL, or 100 μg/mL or more. In some embodiments, the concentration of glutathione in the composition is 1 μg/mL-5 μg/mL, 1 μg/mL-10 μg/mL, 1 μg/mL-15 μg/mL, 1 μg/mL-20 μg/mL, 1 μg/mL-25 μg/mL, 1 μg/mL-30 μg/mL, 1 μg/mL-35 μg/mL, 1 μg/mL-40 μg/mL, 1 μg/mL-45 μg/mL, 1 μg/mL-50 μg/mL, 1 μg/mL-55 μg/mL, 1 μg/mL-60 μg/mL, 1 μg/mL-65 μg/mL, 1 μg/mL-70 μg/mL, 1 μg/mL-75 μg/mL, 1 μg/mL-80 μg/mL, 1 μg/mL-85 μg/mL, 1 μg/mL-90 μg/mL, 1 μg/mL-95 μg/mL, 1 μg/mL-100 μg/mL, 5 μg/mL-10 μg/mL, 5 μg/mL-15 μg/mL, 5 μg/mL-20 μg/mL, 5 μg/mL-25 μg/mL, 5 μg/mL-30 μg/mL, 5 μg/mL-35 μg/mL, 5 μg/mL-40 μg/mL, 5 μg/mL-45 μg/mL, 5 μg/mL-50 μg/mL, 5 μg/mL-60 μg/mL, 5 μg/mL-70 μg/mL, 5 μg/mL-80 μg/mL, 5 μg/mL-90 μg/mL, 5 μg/mL-100 μg/mL, 10 μg/mL-15 μg/mL, 10 μg/mL-20 μg/mL, 10 μg/mL-25 μg/mL, 10 μg/mL-30 μg/mL, 10 μg/mL-35 μg/mL, 10 μg/mL-40 μg/mL, 10 μg/mL-45 μg/mL, 10 μg/mL-50 μg/mL, 10 μg/mL-60 μg/mL, 10 μg/mL-70 μg/mL, 10 μg/mL-80 μg/mL, 10 μg/mL-90 μg/mL, 10 μg/mL-100 μg/mL, 15 μg/mL-20 μg/mL, 15 μg/mL-25 μg/mL, 15 μg/mL-30 μg/mL, 15 μg/mL-35 μg/mL, 15 μg/mL-40 μg/mL, 15 μg/mL-45 μg/mL, 15 μg/mL-50 μg/mL, 15 μg/mL-60 μg/mL, 15 μg/mL-70 μg/mL, 15 μg/mL-80 μg/mL, 15 μg/mL-90 μg/mL, 15 μg/mL-100 μg/mL, 20 μg/mL-25 μg/mL, 20 μg/mL-30 μg/mL, 20 μg/mL-35 μg/mL, 20 μg/mL-40 μg/mL, 20 μg/mL-45 μg/mL, 20 μg/mL-50 μg/mL, 20 μg/mL-60 μg/mL, 20 μg/mL-70 μg/mL, 20 μg/mL-80 μg/mL, 20 μg/mL-90 μg/mL, 20 μg/mL-100 μg/mL, 25 μg/mL-30 μg/mL, 25 μg/mL-35 μg/mL, 25 μg/mL-40 μg/mL, 25 μg/mL-45 μg/mL, 25 μg/mL-50 μg/mL, 25 μg/mL-60 μg/mL, 25 μg/mL-70 μg/mL, 25 μg/mL-80 μg/mL, 25 μg/mL-90 μg/mL, 25 μg/mL-100 μg/mL, 30 μg/mL-35 μg/mL, 30 μg/mL-40 μg/mL, 30 μg/mL-45 μg/mL, 30 μg/mL-50 μg/mL, 30 μg/mL-60 μg/mL, 30 μg/mL-70 μg/mL, 30 μg/mL-80 μg/mL, 30 μg/mL-90 μg/mL, 30 μg/mL-100 μg/mL, 35 μg/mL-40 μg/mL, 35 μg/mL-45 μg/mL, 35 μg/mL-50 μg/mL, 35 μg/mL-60 μg/mL, 35 μg/mL-70 μg/mL, 35 μg/mL-80 μg/mL, 35 μg/mL-90 μg/mL, 35 μg/mL-100 μg/mL, 40 μg/mL-45 μg/mL, 40 μg/mL-50 μg/mL, 40 μg/mL-60 μg/mL, 40 μg/mL-70 μg/mL, 40 μg/mL-80 μg/mL, 40 μg/mL-90 μg/mL, 40 μg/mL-100 μg/mL, 45 μg/mL-50 μg/mL, 45 μg/mL-60 μg/mL, 45 μg/mL-70 μg/mL, 45 μg/mL-80 μg/mL, 45 μg/mL-90 μg/mL, 45 μg/mL-100 μg/mL, 50 μg/mL-60 μg/mL, 50 μg/mL-70 μg/mL, 50 μg/mL-80 μg/mL, 50 μg/mL-90 μg/mL, 50 μg/mL-100 μg/mL, 60 μg/mL-70 μg/mL, 60 μg/mL-80 μg/mL, 60 μg/mL-90 μg/mL, 60 μg/mL-100 μg/mL, 70 μg/mL-80 μg/mL, 70 μg/mL-90 μg/mL, 70 μg/mL-100 μg/mL, 80 μg/mL-90 μg/mL, 80 μg/mL-100 μg/mL, or 90 μg/mL-100 μg/mL.

In some embodiments, the supplemental solution comprises catalase, superoxide dismutase, glutathione, vitamin E, and 2, 3, 4, 5, 6, 7, 8, 9, 10, 11, 12, 13, 14, or all 15 of the following components: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3). For example, in some embodiments, the composition comprises catalase, superoxide dismutase, glutathione, vitamin E, and biotin. In another embodiment, the composition comprises catalase, superoxide dismutase, glutathione, vitamin E, biotin, and vitamin A. In one embodiment, the composition comprises catalase, superoxide dismutase, glutathione, vitamin E, biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

In some aspects, the disclosure provides a composition comprising a supplemental solution in combination with at least one preservation solution. Supplemental solutions are serum-free cell culture supplements, generally used for growth and viability in culture. Examples of supplemental solutions include B-27™ (Gibco™), NS21 supplement (Sigma-Aldrich), GS21™ supplement (GlobalStem), Prime-XV IS21 supplement (Irvine Scientific/FujiFilm), and Gem21 NEUROPLEX™ serum-free supplement (GeminiBio). Therefore, in some embodiments, the composition comprises B-27™ (Gibco™), NS21 supplement (Sigma-Aldrich), GS21™ supplement (GlobalStem), Gem21 NEUROPLEX™ serum-free supplement (GeminiBio), or a combination thereof.

As an example, B-27™ is a commercially available serum-free cell culture supplement, typically used to support growth and viability of embryonic, post-natal, and adult hippocampal cells and other central nervous system (CNS) neurons. B-27 is available, for example, from ThermoFisher Scientific. In one embodiment, the composition comprises B-27™ in combination with the UW solution.

In some embodiments, the supplemental solution is present at a concentration of 0.1% (v/v), 0.2% (v/v), 0.3% (v/v), 0.4% (v/v), 0.5% (v/v), 0.6% (v/v), 0.7% (v/v), 0.8% (v/v), 0.9% (v/v), 1% (v/v), 1.25% (v/v), 1.5% (v/v), 1.75% (v/v), 2% (v/v), 2.25% (v/v), 2.5% (v/v), 2.75% (v/v), 3% (v/v), 3.25% (v/v), 3.5% (v/v), 3.75% (v/v), 4% (v/v), 4.5% (v/v), 5% (v/v), 5.5% (v/v), 6% (v/v), 6.5% (v/v), 7% (v/v), 7.5% (v/v), 8% (v/v), 8.5% (v/v), 9% (v/v), 9.5% (v/v), 10% (v/v) or more relative to the preservation solution.

In some embodiments, the composition is sterile; for example, the composition is Current Good Manufacturing Practice (cGMP)-compliant. CGMP regulations are put in place and enforced by the Food and Drug Administration (FDA) to ensure that formulations are safe for their intended purpose. With respect to biotechnology, cGMP regulations relate to the identity, strength, quality, and purity of a formulation. CGMP regulations are available online from the FDA's website and are known to one of ordinary skill in the art. Likewise, a composition described herein may be “good manufacturing practice-compliant” (GMP-compliant), meaning that it would meet the requirements of the European Medicines Agency (EMA) and/or “Japanese Good Manufacturing Practice-compliant,” representing a composition that would comply with the regulations set forth by the Japanese Pharmaceuticals and Medical Device Agency.

### Preservation of Organs and Tissues

Provided herein are methods for preserving organs and tissues. In some embodiments, the method comprises contacting the organ or tissue to be preserved with any one of the compositions described herein.

In some embodiments, the step of contacting the organ or tissue with the composition comprises immersing, infusing, flushing, or perfusing. Any other suitable procedure of contacting may be used (e.g., coating, permeating, pouring, diffusing), such that an effective amount of the composition saturates the organ or tissue. An effective amount of the composition is an amount sufficient to prolong the viability or preservation time of the organ or tissue; that is, the amount is sufficient such that the organ or tissue is maintained so that it may be successfully transplanted into a donor subject or such that it possesses the characteristics of living organs or tissues (e.g., maintains or increases the number of actively growing or dividing cells). In some embodiments, the immersing, infusing, flushing, or perfusing steps are undertaken to remove blood residue from the organ or tissue that may limit subsequent preservation steps and to replace the blood with the composition.

In some embodiments, the organ or tissue is flushed, infused, perfused with any one of the compositions described herein. In some embodiments, the organ or tissue is immersed (e.g., stored) in any one of the compositions described herein. In one embodiment, the organ or tissue is flushed after cold storage (e.g., 4° C.) prior to its transplantation into a recipient.

In one embodiment, the organ or tissue is contacted with the composition for one minute to 14 days. In some embodiments, the organ or tissue is contacted with the composition for 30 minutes to 50 hours. In some embodiments, the organ or tissue is contacted with the composition for 4-8 hours.

In some embodiments, the organ or tissue is contacted with any one of the compositions provided herein for 10 seconds to 1 hour, 20 seconds to 1 hour, 30 seconds to 1 hour, 40 seconds to 1 hour, 50 seconds to 1 hour, 1 minute to 1 hour, 15 minutes to 1 hour, 30 minutes to 1 hour, 45 minutes to 1 hour, 1 hour-2 hours, 1 hour-3 hours, 1 hour-4 hours, 1 hour-5 hours, 1 hour-6 hours, 1 hour-7 hours, 1 hour-8 hours, 1 hour-9 hours, 1 hour-10 hours, 1 hour-11 hours, 1 hour-12 hours, 2 hours-3 hours, 2 hours-4 hours, 2 hours-5 hours, 2 hours-6 hours, 2 hours-7 hours, 2 hours-8 hours, 2 hours-9 hours, 2 hours-10 hours, 2 hours-11 hours, 2 hours-12 hours, 3 hours-4 hours, 3 hours-5 hours, 3 hours-6 hours, 3 hours-7 hours, 3 hours-8 hours, 3 hours-9 hours, 3 hours-10 hours, 3 hours-11 hours, 3 hours-12 hours, 4 hours-5 hours, 4 hours-6 hours, 4 hours-7 hours, 4 hours-8 hours, 4 hours-9 hours, 4 hours-10 hours, 4 hours-11 hours, 4 hours-12 hours, 5 hours-6 hours, 5 hours-7 hours, 5 hours-8 hours, 5 hours-9 hours, 5 hours-10 hours, 5 hours-11 hours, 5 hours-12 hours, 6 hours-7 hours, 6 hours-8 hours, 6 hours-9 hours, 6 hours-10 hours, 6 hours-11 hours, 6 hours-12 hours, 7 hours-8 hours, 7 hours-9 hours, 7 hours-10 hours, 7 hours-11 hours, 7 hours-12 hours, 8 hours-9 hours, 8 hours-10 hours, 8 hours-11 hours, 8 hours-12 hours, 9-hours 10 hours, 9 hours-11 hours, 9 hours-12 hours, 10 hours-11 hours, 10 hours-12 hours, 11 hours-12 hours, or 12 hours-1 day. In some embodiments, the organ or tissue is contacted with the composition for 1 day-2 days, 1 day-3 days, 1 day-4 days, 1 day-5 days, 1 day-6 days, 1 day-7 days, 1 day-2 weeks, 2 days-3 days, 2 days-4 days, 2 days-5 days, 2 days-6 days, 2 days-7 days, 2 days-2 weeks, 3 days-4 days, 3 days-5 days, 3 days-6 days, 3 days-7 days, 3 days-2 weeks, 4 days-5 days, 4 days-6 days, 4 days-7 days, 4 days-2 weeks, 5 days-6 days, 5 days-7 days, 5 days-2 weeks, 6 days-7 days, 6 days-2 weeks, 7 days-2 weeks, 1.5 weeks-2 weeks, 2 weeks-3 weeks, 2 weeks-4 weeks, 2 weeks-6 weeks, 2 weeks-2 months, 3 weeks-4 weeks, 3 weeks-6 weeks, 3 weeks-2 months, 4 weeks-6 weeks, or 4 weeks-2 months.

In some embodiments, the organ or tissue is contacted with the composition for 10 seconds, 20 seconds, 30 seconds, 40 seconds, 50 seconds, 1 minute, 2 minutes, 3 minutes, 4 minutes, 5 minutes, 6 minutes, 7 minutes, 8 minutes, 9 minutes, 10 minutes, 15 minutes, 20 minutes, 25 minutes, 30 minutes, 35 minutes, 40 minutes, 45 minutes, 50 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, 35 hours, 40 hours, 45 hours, 50 hours, 55 hours, 60 hours, 3 days, 3.5 days, 4 days, 4.5 days, 5 days, 5.5 days, 6 days, 6.5 days, 7 days, 8 days, 9 days, 10 days, or longer.

In some embodiments, the temperature of the composition is maintained throughout the contacting step or steps. In other embodiments, the temperature of the composition varies between contacting steps. For example, the composition may be at physiological temperatures during the initial infusing or flushing steps, but may be at a lower temperature (e.g., 4° C. or 0° C.) for the immersing (e.g., storing) steps. In some embodiments, the composition is 0° C. to 38° C., for example 1° C., 2° C., 3° C., 4, 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., or 38° C. In some embodiments, the composition is 4° C. In some embodiments, the composition is 15° C. In some embodiments, the composition is 37° C. In some embodiments, the temperature of the composition ranges from 0° C.-1° C., 0° C.-2° C., 0° C.-3° C., 0° C.-4° C., 0° C.-5° C., 0° C.-6° C., 0° C.-7° C., 0° C.-8° C., 0° C.-9° C., 0° C.-10° C., 1° C.-2° C., 1° C.-3° C., 1° C.-4° C., 1° C.-5° C., 1° C.-6° C., 1° C.-7° C., 1° C.-8° C., 1° C.-9° C., 1° C.-10° C., 2° C.-3° C., 2° C.-4° C., 2° C.-5° C., 2° C.-6° C., 2° C.-7° C., 2° C.-8° C., 2° C.-9° C., 2° C.-10° C., 3° C.-4° C., 3° C.-5° C., 3° C.-6° C., 3° C.-7° C., 3° C.-8° C., 3° C.-9° C., 3° C.-10° C., 4° C.-5° C., 4° C.-6° C., 4° C.-7° C., 4° C.-8° C., 4° C.-9° C., 4° C.-10° C., 5° C.-6° C., 5° C.-7° C., 5° C.-8° C., 5° C.-9° C., or 5° C.-10° C. In some embodiments, the temperature of the composition ranges from 30° C.-31° C., 30° C.-32° C., 30° C.-33° C., 30° C.-34° C., 30° C.-35° C., 30° C.-36° C., 30° C.-37° C., 31° C.-32° C., 31° C.-33° C., 31° C.-34° C., 31° C.-35° C., 31° C.-36° C., 31° C.-37° C., 32° C.-33° C., 32° C.-34° C., 32° C.-35° C., 32° C.-36° C., 32° C.-37° C., 33° C.-34° C., 33° C.-35° C., 33° C.-36° C., 33° C.-37° C., 34° C.-35° C., 34° C.-36° C., 34° C.-37° C., 35° C.-36° C., 35° C.-37° C., 36° C.-37° C., 30° C.-38° C., 31° C.-38° C., 32° C.-38° C., 33° C.-38° C., 34° C.-38° C., 35° C.-38° C., 36° C.-38° C., or 37° C.-38° C., for example, when it is initially contacted with the organ or tissue.

After the organ or tissue has been contacted (e.g., immersed, infused, flushed, and/or perfused) or stored with any of the compositions described herein, it may be transplanted into a subject in need thereof. In certain embodiments, the subject is a human. In some embodiments, the subject is an animal. The animal may be of either sex and may be at any stage of development. In some embodiments, the subject is a mammal. In some embodiments, the subject is a domesticated animal, such as a dog, cat, cow, pig, horse, sheep, or goat. In certain embodiments, the subject is a companion animal, such as a dog or cat. In one embodiment, the subject is a livestock animal, such as a cow, pig, horse, sheep, or goat. In certain embodiments, the subject is a zoo animal. In another embodiment, the subject is a research animal such as a rodent (e.g., mouse, rat), dog, pig, or non-human primate. In some embodiments, the animal is a genetically engineered animal. In some embodiments, the animal is a transgenic animal.

In some embodiments, the organ is selected from the group consisting of heart, kidney, liver, lungs, pancreas, stomach, intestine, uterus, thymus, hand, foot, arm, head, hair follicle and face. In one embodiment, the organ is a heart. In some embodiments, the organ is a kidney. In some embodiments, the organ is a liver. In some embodiments, the organ is a lung. In some embodiments, the organ is a pancreas. In some embodiments, the organ is a stomach.

In some embodiments, the tissue is selected from the group consisting of cornea, bone, tendon, muscle, skin, pancreatic islet cells, heart valve, hematopoietic stem cells, mesenchymal stem/stromal cells, keratinocytes and other epithelial cells, nerve, and vascular tissue (e.g., vein, artery). In some embodiments, the tissue comprises hematopoietic stem cells. In some embodiments, the tissue is nervous tissue. In some embodiments, the tissue is vascular tissue (e.g., a vein or artery). In some embodiments, the tissue is cornea. In some embodiments, the tissue is bone. In some embodiments, the tissue is tendon. In some embodiments, the tissue is skin.

In another aspect, the present application provides methods of prolonging organ or tissue survival ex vivo, the methods comprising contacting the organ or tissue with any of the compositions provided herein, and wherein the composition further comprises a preservation solution.

In a further aspect, the present disclosure provides methods of increasing transplant success, the methods comprising contacting the organ or tissue to be transplanted with a composition provided herein, and wherein the composition further comprises a preservation solution. In some embodiments, increased transplant success may be indicated by one or more indicia of improved survival rate (e.g., of the transplant subject and/or of the transplanted organ or tissue). Improved survival rate of the transplant subject and/or the transplanted organ or tissue may be shown by a variety of metrics including, but not limited to, reduced number of hospitalizations, reduced time to hospital discharge, reduced morbidity, reduced mortality, reduced or delayed primary graft dysfunction, increased overall survival rates (e.g., 1 week, 2 weeks, 3 weeks, 1 month, 2 month, 3 months, 4 months, 5 months, 6 months, 8 months, 10 months, 1 year, 1.5 years, 2 years, 3 years, 4 years, 5 years, or more time after the transplant procedure), and improved or maintained transplanted organ or tissue health (e.g., as evidenced from biopsies and/or pathology).

In another aspect, the present application provides methods of preserving contractile function in contractile tissue, the methods comprising contacting the contractile tissue with a composition described herein, and wherein the composition further comprises a preservation solution. The contractile tissue, for example, may be muscle tissue, such as cardiac, skeletal, and/or smooth muscle tissue. In some embodiments, the contractile tissue comprises cardiomyocytes. In some embodiments, the contractile tissue is preserved in vitro, in situ, or ex vivo.

Compositions described herein may be used, for example, to prolong organ or tissue survival ex vivo, wherein the composition further comprises a preservation solution and wherein the composition contacts the organ or tissue. The compositions described herein may also be for use in increasing transplant success, wherein the composition further comprises a preservations solution and wherein the composition contacts an organ or tissue to be transplanted. Such compositions may also be for use in preserving contractile tissue, wherein the composition is contacted with the contractile tissue and wherein the composition further comprises a preservation solution.

Kits

In another aspect, kits for preserving an organ or tissue for transplantation are provided. The kits provided may comprise a composition described herein and a container (e.g., a vial, ampule, bottle, syringe, catheter, and/or dispenser package, or other suitable container). In some embodiments, provided kits may house separate components of the composition in separate containers. For example, a first container may hold a preservation solution described herein and a second container may hold a composition comprising superoxide dismutase, catalase, vitamin E, and glutathione, and optionally, one or more of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3). In some embodiments, any of the compositions provided herein may be lyophilized, and therefore, an optional additional container may comprise a pharmaceutical excipient for dilution or re-suspension of a composition described herein.

In one embodiment, a first container comprises a preservation solution described herein (e.g., UW solution) and a second container comprises B-27™ (Gibco™)

In some embodiments, the kits are useful for prolonging organ or tissue survival ex vivo, increasing organ or tissue transplant success, and/or preserving contractile tissue. Therefore, in some embodiments, the container(s) of the kit are catheter(s) and/or syringe(s). In other embodiments, the kits further comprise at least one catheter or syringe (e.g., for use perfusing, infusing, or otherwise contacting the composition with an organ or tissue).

In some embodiments, kits described herein further include instructions for using the kit.

In some embodiments, the kits of the present invention further include one or more additional approved pharmaceutical agent(s). In certain embodiments, the instructions include a notice in the form prescribed by a governmental agency such as the U.S. Food and Drug Administration (FDA) regulating the manufacture, use, or sale of pharmaceutical products, which notice reflects approval by the agency of manufacture, use, or sale for human administration.

### EXAMPLES

In order that the invention described herein may be more fully understood, the following examples are set forth. The examples described in this application are offered to illustrate the compositions and methods provided herein and are not to be construed in any way as limiting their scope.

### B27 Supplementation Preserves Heart Function

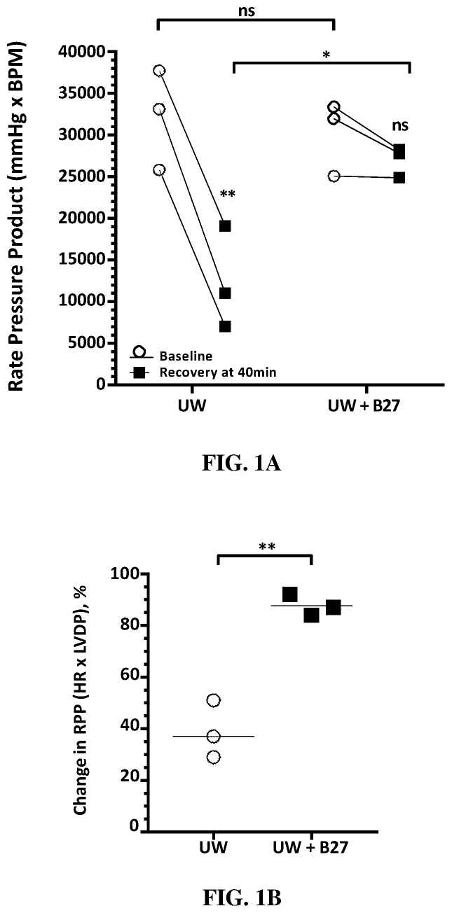

The effect on B27 supplement on preservation of function was examined. Rat hearts were harvested and affixed on a Langendorff apparatus. Baseline heart rate and ejection fraction were recorded for 20 minutes. The hearts were then perfused with University of Wisconsin (UW) solution supplemented with B27 and maintained in cold storage (4° C.) for five hours. Following the incubation, the hearts were then reattached to the Langerdorff apparatus, and data was collected for 50 minutes. FIG. 1A demonstrates that the hearts perfused with UW solution and B27 supplement did not have a significant decline in function over the five hour period, whereas hearts that were perfused with UW solution only did show a significant decline. The change in function between the two groups was also significant (FIG. 1B). Accordingly, B27 supplementation produces strong cardioprotection in vitro that is superior to that of the UW solution.

### B27 Supplementation Promotes Human iPS-derived Cardiomyocyte Recovery Post-UW Treatment

To test whether B27 would confer a protective effect when provided to human iPS-derived cardiomyocytes (iCM) after UW solution exposure, beat rate, cell apoptosis (caspase-3 staining), and beating velocity were examined.

Beat rate was determined as follows. Once the physiologically relevant beating of reseeded iCMs recommenced (typically between 5-12 days after reseeding), the baseline beat rate was taken via time-lapse imaging using Axio Observer.Z1 microscope. Subsequently, media on iCMs was replaced with University of Wisconsin Cardioplegic Solution (UW) (Bridge to Life, USA) alone or supplemented with various preparations of ASC-CM. iCMs were incubated in UW ±ASC-CM for 2-8 hours either at 4° C. or 37° C. After the UW exposure was completed, UW was replaced with RPMI alone or supplemented with either ASC-CM or 2% (v/v) B27 media supplement. Timelapse videos were taken intermittently for 24 hours after UW treatment was completed.

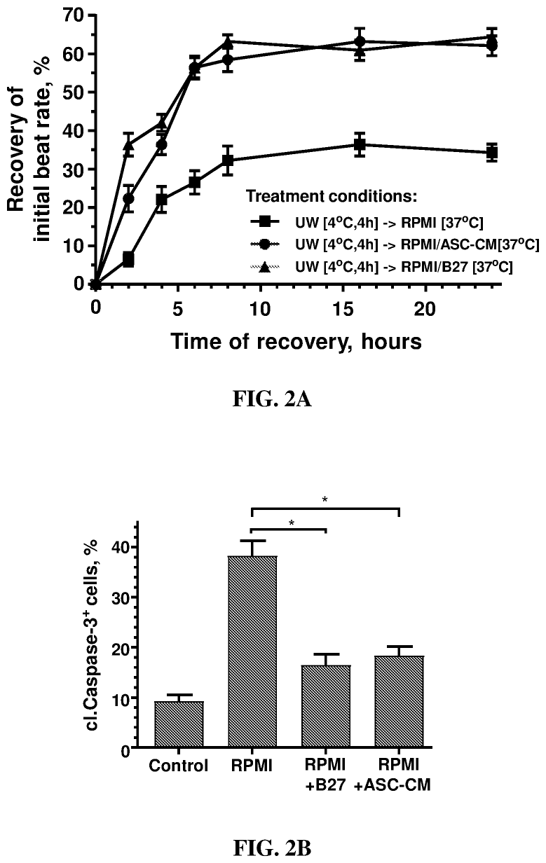

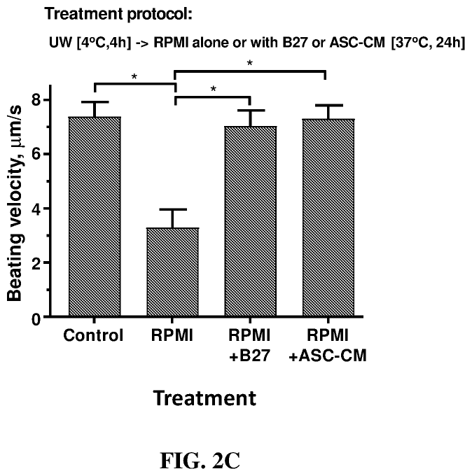

As shown in FIG. 2A, iCMs exposed to UW for 4 hours at 37° C. efficiently restore their beating rate when allowed to recover in RPMI media supplemented with B27, confirming rapid action of the B27 in this experimental design.

To examine cell apoptosis, caspase-3 staining was used. iCMs, before and after UW exposure, and human left ventricle samples were stained for cleaved caspase-3 (Cell Signaling), with secondary staining of goat anti-rabbit Alexa Fluor 547. To reveal nuclei, samples were incubated with DAPI. To perform semi-quantitative analysis of cleaved caspase-3 expression, three separate, randomly selected fields of view (FOV) were imaged for each sample. The number of nuclei positive for caspase-3 was determined and normalized to the total number of nuclei in each respective FOV, to yield the percent of caspase-3 positive cells; values for each FOVs averaged to identify an apoptosis frequency.

B27 treatment was found to substantially decrease (65%) the level of cell apoptosis as demonstrated by probing iCM monolayers for cleaved caspase-3 24-hours post-recovery from UW (FIG. 2B).

Beating velocity was examined with an assay as follows. A block-matching algorithm was applied to analyze contractility of iCMs. Briefly, the timelapse videos of iCMs were recorded at 30 fps and then exported as a sequence of single-frame images. The images were then divided into N×N pixel blocks. The contractility of iCMs was detected by tracking the movement of each individual block. Specifically, motion of a given block at the k^{th} frame was tracked by matching its intensity to an identically-sized block in the (k+1)^{th} frame within a square searching area of width of (N+2w). The values of N and w were chosen as 16 and 7, respectively, in this study to compromise between calculation cost and accuracy of the block-matching method. The Mean Absolute Difference (MAD) method was used as matching criterion for block movement as given below:

$$M ( i , j ) = \frac{1}{{N}^{2}} {\sum }_{m = 1}^{N} {\sum }_{n = 1}^{N} \vert {f}_{k} ( m , n ) - {f}_{k + 1} ( m + i , n + j ) \vert - w \leq i , j \leq w$$

where ƒₖ(m, n) is the intensity at coordinates (m, n) of a given block at the k^{th} frame and ƒₖ₊1(m+i, n+j) represent the intensity at new coordinates (m+i, n+j) of the corresponding block at the (k+1)^{th} frame. The movement of the block was determined as min(M (i,j)). The above procedure was repeated for each individual block in the image to generate an array of motion vectors demonstrating the beating of iCMs for each time frame. Taking all frames together, a time series of motion vectors representing the beating velocity of iCMs was obtained. The peak velocity for each vector determined over time is then averaged with that of all other vectors within each beating cluster to yield a single value representing each such active syncytium.

As shown in FIG. 2C, B27 treatment restored the beating velocity to the level depicted for iCMs incubated in control media.

### B27 Supplementation Improves Preservation of Rat Heart Function

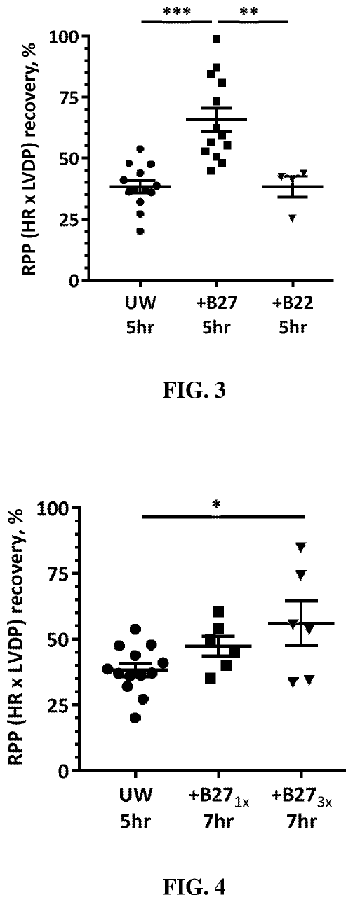

Hearts were harvested from young adult rats and immediately placed on the Langendorff apparatus to record baseline heart functions (expressed as heart rate multiplied by left ventricular developed pressure) for 20 minutes (min). The hearts were then disconnected from the machine, infused with ice cold UW cardioplegic solution alone or augmented with either B27 or B22 (B27 minus antioxidants) and stored in the same solution for 5 hours at 4° C. After storage, hearts were reattached to the apparatus and heart function recovery was monitored for one hour. The results are shown in FIG. 3, which illustrates maximal heart function at 40±5 min after reattachment. The data demonstrates that supplementation of the UW solution with B27 significantly improves the preservation of rat heart function as compared to the recovery of the hearts stored in UW alone or in UW supplemented with B22.

The effects of supplementing the UW solution with different concentrations of B27 were examined. Hearts were harvested from young adult rats and immediately placed on the Langendorff apparatus to record baseline heart functions for 20 min. The hearts were then disconnected from machine, and infused either with ice cold UW cardioplegic solution and stored for 5 hours at 4° C. or with UW+1×B27 or UW+3×B27 and stored for 7 hours at 4° C. After storage, the hearts were reattached on apparatus and heart function recovery was monitored for 1 hour. The maximal heart function at 40±5 min after reattachment for each group is shown in FIG. 4 and demonstrates that supplementation of UW solution with 3×B27 allows to extend heart storage for an additional 2 hours without compromising degree of function recovery. This is three hours beyond the typically clinically permissible time (four hours) and significantly exceeds the average rate pressure product's percent recovery from baseline without B27 by at least two hours.

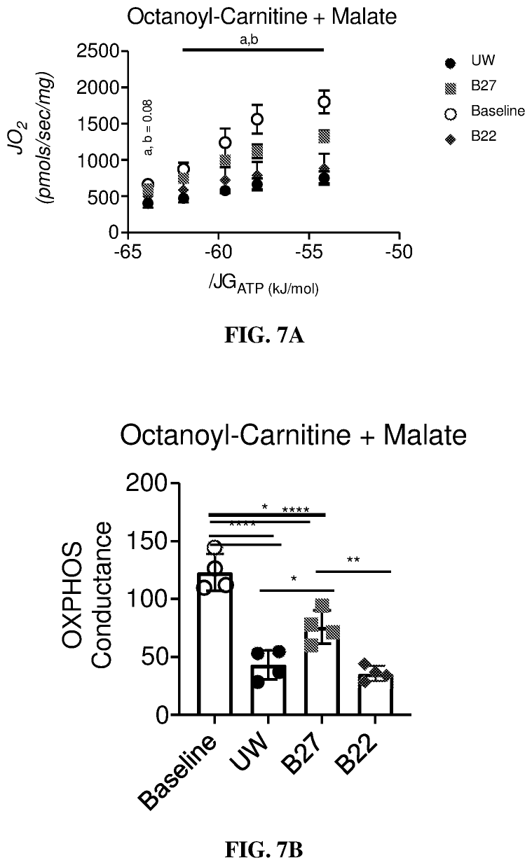

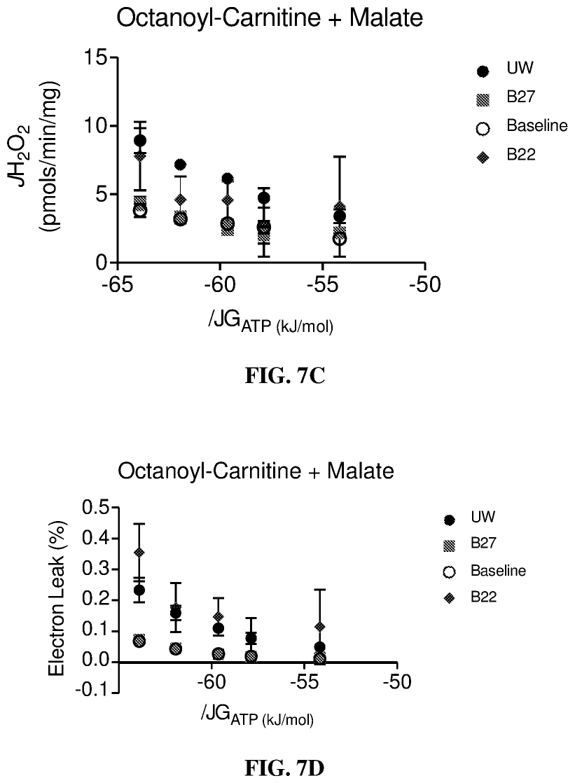

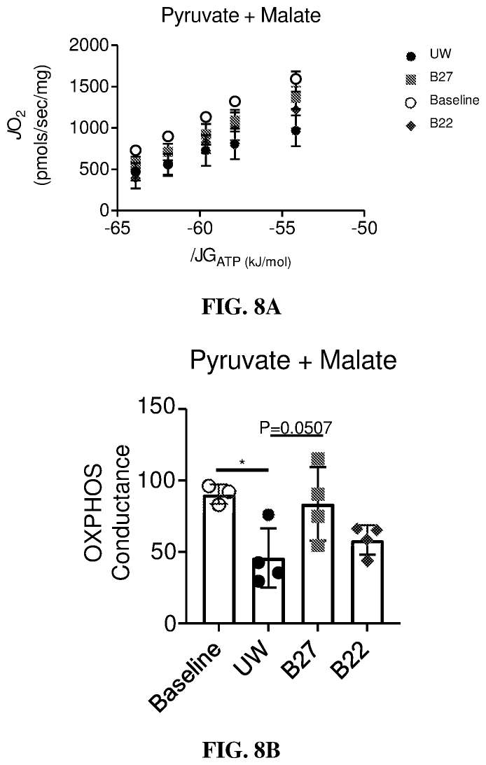

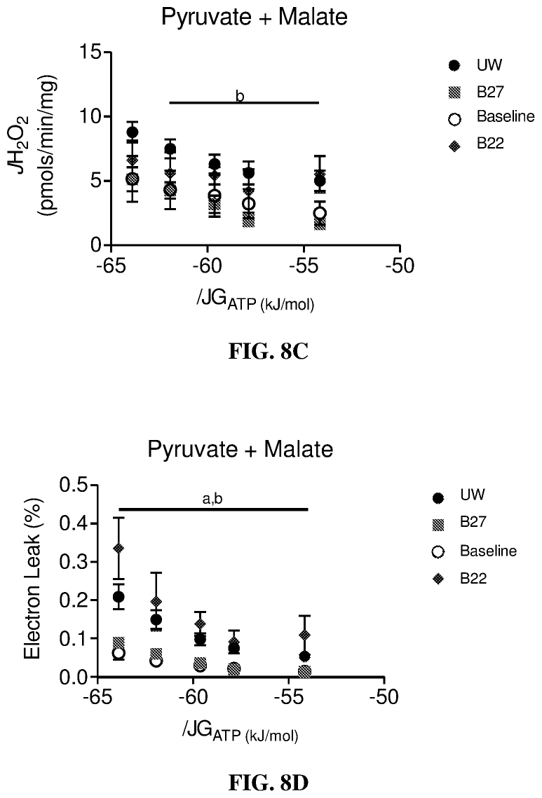

Rat heart mitochondrial function was also assessed. Hearts were harvested from young adult rats and infused with ice cold UW cardioplegic solution alone or augmented with either B27 or B22 and stored in the same solution for 5 hours at 4° C. Immediately after storage, the hearts were subjected to assessments of mitochondrial function in isolated cardiomyocyte bundles. Hearts not exposed to cold cardioplegia were immediately used to establish baseline data for the mitochondrial function. As shown in FIGS. 7A-7D and 8A-8D, storage of hearts in UW solution supplemented with B27 resulted in marked preservation of all measured aspects of rat heart mitochondrial function, including improved oxygen consumption, decreased H₂O₂ generation and decreased electron leak.

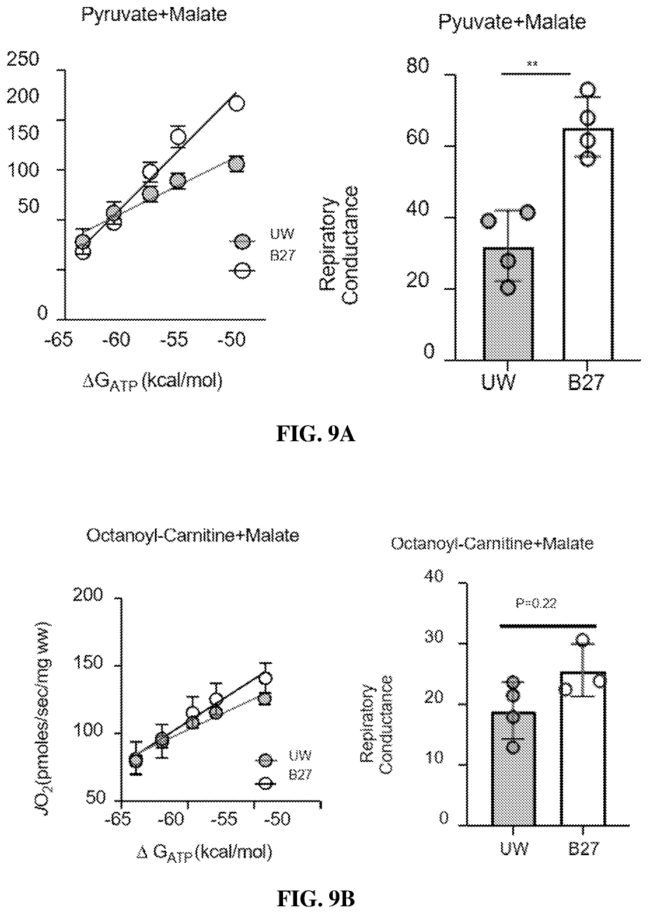

Finally, rat heart mitochondrial function following reperfusion was assessed. Hearts were harvested from young adult rats and infused with ice cold UW cardioplegic solution alone or augmented with either B27 or B22 and stored in the same solution for 5 hours at 4° C. After storage, hearts were attached to Langendorff apparatus and perfused with oxygenated Krebs-Henseleit buffer for one hour to model the effects of reperfusion. The hearts were then subjected to mitochondrial function assessments in isolated cardiomyocyte bundles. As shown in FIGS. 9A-9B, storage of hearts in UW solution supplemented with B27 resulted persistently improved mitochondrial activity following one hour of exposure to reperfusion conditions.

### B27 Supplementation Promotes Human iPS-derived Cardiomyocyte Recovery Post-UW Treatment

To test whether B27 would confer a protective effect when provided to human iPS-derived cardiomyocytes (iCM) after UW solution exposure, beat rate and beating velocity were examined.

Human induced cardiomyocytes (iCM), with established physiologically-relevant beating, were used. The baseline beat rate was recorded initially via time-lapse imaging using an Axio Observer.Z1 microscope. Subsequently, the culture media above the iCM was replaced with UW solution either alone or supplemented with B27 and incubated for 4 hours at 4° C. After the UW exposure was completed, the UW solution (alone or supplemented) was replaced with the iCM complete culture media. Time-lapse videos were taken intermittently for 24 hours after the UW treatment/cold storage was completed and the results are shown in FIG. 5. Human cardiomyocytes stored in UW solution supplemented with B27 were observed to have significantly improved rates and degree of recovery of beating activity relative to the iCM treated with UW solution alone.

To examine beating velocity, a previously developed block-matching algorithm was applied to analyze contractility of iCM. Briefly, the time-lapse videos of iCM were recorded at 30 frame per second and then exported as a sequence of single-frame images. The images were then divided into N×N pixel blocks. The contractility of iCM was detected by tracking the movement of each individual block. This procedure was repeated for each individual block in the image to generate an array of motion vectors, demonstrating the beating of iCM for each time frame. This was done for all frames of the time-lapse video to create a time series of iCM beating velocity vectors. The peak velocity for each vector determined over time was then averaged with that of all other vectors within each beating cluster to yield a single value representing each such active syncytium.

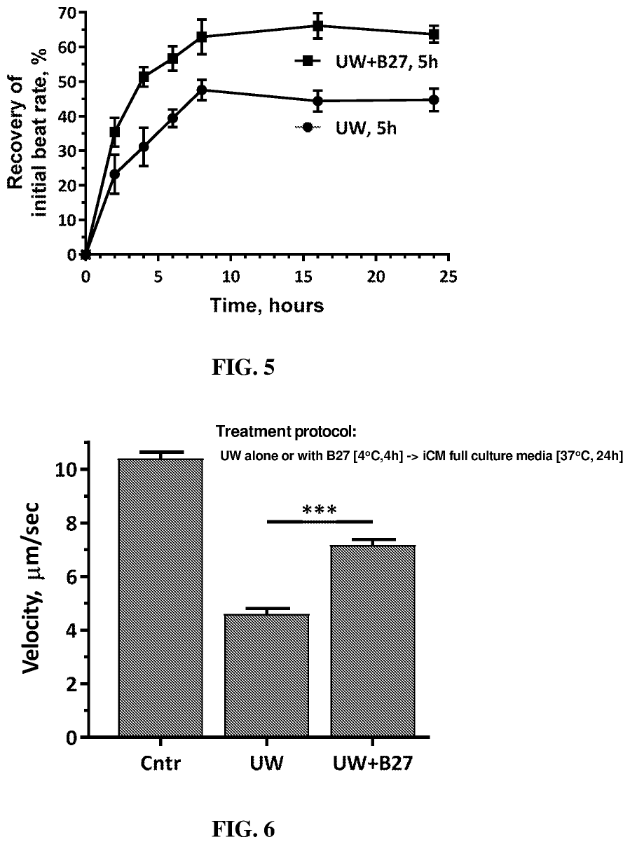

The results are shown in FIG. 6. The beating velocity of the iCM was evaluated in the control cells and cells after exposure to UW ±B27 at 4° C. for 4 hours, followed by incubation in iCM complete (full) culture media for 24 hours. Similarly to the beat rate data, the human iCM stored in UW solution supplemented with B27 showed significantly improved velocity of cell contractile movement.

### References

1. Singhal A K, Abrams J D, Mohara J, Hasz R D, Nathan H M, Fisher C A, Furukawa S and Goldman B I. Potential suitability for transplantation of hearts from human non-heart-beating donors: data review from the Gift of Life Donor Program. J Heart Lung Transplant. 2005;24:1657-64.

2. Taylor D O, Stehlik J, Edwards L B, Aurora P, Christie J D, Dobbels F, Kirk R, Kucheryavaya A Y, Rahmel A O and Hertz M I. Registry of the International Society for Heart and Lung Transplantation: Twenty-sixth Official Adult Heart Transplant Report-2009. J Heart Lung Transplant. 2009;28:1007-22.

3. Iyer A, Gao L, Doyle A, Rao P, Jayewardene D, Wan B, Kumarasinghe G, Jabbour A, Hicks M, Jansz P C, Feneley M P, Harvey R P, Graham R M, Dhital K K and Macdonald P S. Increasing the tolerance of DCD hearts to warm ischemia by pharmacological postconditioning. Am J Transplant. 2014;14:1744-52.

4. Wang M, Zhang W, Crisostomo P, Markel T, Meldrum K K, Fu X Y and Meldrum D R. STAT3 mediates bone marrow mesenchymal stem cell VEGF production. J Mol Cell Cardiol. 2007;42:1009-15.

5. Crisostomo PR, Wang Y, Markel T A, Wang M, Lahm T and Meldrum D R. Human mesenchymal stem cells stimulated by TNF-alpha, LPS, or hypoxia produce growth factors by an NF kappa B- but not JNK-dependent mechanism. Am J Physiol Cell Physiol. 2008;294:C675-82.

6. Young J B, Hauptman P J, Naftel D C, Ewald G, Aaronson K, Dec G W, Taylor D O, Higgins R, Platt L and Kirklin J. Determinants of early graft failure following cardiac transplantation, a 10-year, multi-institutional, multivariable analysis. J Heart Lung Transplant. 2001;20:212.

7. Johnson M R, Meyer K H, Haft J, Kinder D, Webber S A and Dyke D B. Heart transplantation in the United States, 1999-2008. Am J Transplant. 2010;10:1035-46.

8. Rehman J, Traktuev D, Li J, Merfeld-Clauss S, Temm-Grove C J, Bovenkerk J E, Pell C L, Johnstone B H, Considine R V and March K L. Secretion of angiogenic and antiapoptotic factors by human adipose stromal cells. Circulation. 2004;109:1292-8.

9. Wang M, Crisostomo P R, Herring C, Meldrum K K and Meldrum D R. Human progenitor cells from bone marrow or adipose tissue produce VEGF, HGF, and IGF-I in response to TNF by a p38 MAPK-dependent mechanism. Am J Physiol Regul Integr Comp Physiol. 2006;291:R880-4.

10. Hoke N N, Salloum F N, Kass D A, Das A and Kukreja R C. Preconditioning by phosphodiesterase-5 inhibition improves therapeutic efficacy of adipose-derived stem cells following myocardial infarction in mice. Stem Cells. 2012;30:326-35.

11. Cai L, Johnstone B H, Cook T G, Liang Z, Traktuev D, Cornetta K, Ingram D A, Rosen E D and March K L. Suppression of hepatocyte growth factor production impairs the ability of adipose-derived stem cells to promote ischemic tissue revascularization. Stem Cells. 2007;25:3234-43.

12. Cai L, Johnstone B H, Cook T G, Tan J, Fishbein M C, Chen P S and March K L. IFATS collection: Human adipose tissue-derived stem cells induce angiogenesis and nerve sprouting following myocardial infarction, in conjunction with potent preservation of cardiac function. Stem Cells. 2009;27:230-7.

13. Landman J, Olweny E, Sundaram C P, Chen C, Rehman J, Lee D I, Shalhav A, Portis A, McDougall E M and Clayman R V. Prospective comparison of the immunological and stress response following laparoscopic and open surgery for localized renal cell carcinoma. J Urol. 2004;171:1456-60.

14. Wei X, Du Z, Zhao L, Feng D, Wei G, He Y, Tan J, Lee W H, Hampel H, Dodel R, Johnstone B H, March K L, Farlow M R and Du Y. IFATS collection: The conditioned media of adipose stromal cells protect against hypoxia-ischemia-induced brain damage in neonatal rats. Stem Cells. 2009;27:478-88.

15. Wang W E, Yang D, Li L, Wang W, Peng Y, Chen C, Chen P, Xia X, Wang H, Jiang J, Liao Q, Li Y, Xie G, Huang H, Guo Y, Ye L, Duan D D, Chen X, Houser S R and Zeng C. Prolyl hydroxylase domain protein 2 silencing enhances the survival and paracrine function of transplanted adipose-derived stem cells in infarcted myocardium. Circ Res. 2013;113:288-300.

16. Bhang S H, Lee S, Shin J Y, Lee T J, Jang H K and Kim B S. Efficacious and clinically relevant conditioned medium of human adipose-derived stem cells for therapeutic angiogenesis. Mol Ther. 2014;22:862-72.

17. Murphy E and Steenbergen C. Mechanisms underlying acute protection from cardiac ischemia-reperfusion injury. Physiol Rev. 2008;88:581-609.

18. Nakao N, Nakayama T, Yahata T, Muguruma Y, Saito S, Miyata Y, Yamamoto K and Naoe T. Adipose tissue-derived mesenchymal stem cells facilitate hematopoiesis in vitro and in vivo: advantages over bone marrow-derived mesenchymal stem cells. Am J Pathol. 2010;177:547-54.

19. Wei X, Zhao L, Zhong J, Gu H, Feng D, Johnstone B H, March K L, Farlow M R and Du Y. Adipose stromal cells-secreted neuroprotective media against neuronal apoptosis. Neurosci Lett. 2009;462:76-9.

20. Fontanilla C V, Gu H, Liu Q, Zhu T Z, Zhou C, Johnstone B H, March K L, Pascuzzi R M, Farlow M R and Du Y. Adipose-derived Stem Cell Conditioned Media Extends Survival time of a mouse model of Amyotrophic Lateral Sclerosis. Sci Rep. 2015;5:16953.

21. Walker C L, Meadows R M, Merfeld-Clauss S, Du Y, March K L and Jones K J. Adipose-derived stem cell conditioned medium impacts asymptomatic peripheral neuromuscular denervation in the mutant superoxide dismutase (G93A) transgenic mouse model of amyotrophic lateral sclerosis. Restor Neurol Neurosci. 2018;36:621-627.

22. Xie J, Broxmeyer H E, Feng D, Schweitzer K S, Yi R, Cook T G, Chitteti B R, Barwinska D, Traktuev D O, Van Demark M J, Justice M J, Ou X, Srour E F, Prockop D J, Petrache I and March K L. Human adipose-derived stem cells ameliorate cigarette smoke-induced murine myelosuppression via secretion of TSG-6. Stem Cells. 2015;33:468-78.

23. Lu H, Cook T, Poirier C, Merfeld-Clauss S, Petrache I, March K L and Bogatcheva N V. Pulmonary Retention of Adipose Stromal Cells Following Intravenous Delivery Is Markedly Altered in the Presence of ARDS. Cell Transplant. 2016;25:1635-1643.

24. Lu H, Poirier C, Cook T, Traktuev D O, Merfeld-Clauss S, Lease B, Petrache I, March K L and Bogatcheva N V. Conditioned media from adipose stromal cells limit lipopolysaccharide-induced lung injury, endothelial hyperpermeability and apoptosis. J Transl Med. 2015;13:67.

25. Prochazka V, Jurcikova J, Lassak O, Vitkova K, Pavliska L, Porubova L, Buszman P P, Krauze A, Fernandez C, Jaluvka F, Spackova I, Lochman I, Jana D, Merfeld-Clauss S, March K L, Traktuev D O and Johnstone B H. Therapeutic Potential of Adipose-Derived Therapeutic Factor Concentrate for Treating Critical Limb Ischemia. Cell Transplant. 2016;25:1623-1633.

26. Ellis B W, Acun A, Can U I and Zorlutuna P. Human iPSC-derived myocardium-on-chip with capillary-like flow for personalized medicine. Biomicrofluidics. 2017;11:024105.

27. Patsch C, Challet-Meylan L, Thoma E C, Urich E, Heckel T, O'Sullivan J F, Grainger S J, Kapp F G, Sun L, Christensen K, Xia Y, Florido M H, He W, Pan W, Prummer M, Warren C R, Jakob-Roetne R, Certa U, Jagasia R, Freskgard P O, Adatto I, Kling D, Huang P, Zon L I, Chaikof EL, Gerszten R E, Graf M, lacone R and Cowan C A. Generation of vascular endothelial and smooth muscle cells from human pluripotent stem cells. Nat Cell Biol. 2015;17:994-1003.

28. Huang C, Gu H, Yu Q, Manukyan M C, Poynter J A and Wang M. Sca-1+cardiac stem cells mediate acute cardioprotection via paracrine factor SDF-1 following myocardial ischemia/reperfusion. PloS one. 2011 ;6:e29246.

29. Huang C, Gu H, Zhang W, Manukyan M C, Shou W and Wang M. SDF-1/CXCR4 mediates acute protection of cardiac function through myocardial STAT3 signaling following global ischemia/reperfusion injury. Am J Physiol Heart Circ Physiol. 2011;301:H1496-505.

30. Wang M, Crisostomo P R, Markel T A, Wang Y and Meldrum D R. Mechanisms of sex differences in TNFR2-mediated cardioprotection. Circulation. 2008;118:S38-45.

31. Wang M, Tsai B M, Crisostomo P R and Meldrum D R. Tumor necrosis factor receptor 1 signaling resistance in the female myocardium during ischemia. Circulation. 2006;114:1282-9.

32. Wang L, Gu H, Turrentine M and Wang M. Estradiol treatment promotes cardiac stem cell (CSC)-derived growth factors, thus improving CSC-mediated cardioprotection after acute ischemia/reperfusion. Surgery. 2014;156:243-52.

33. Burridge P W, Li Y F, Matsa E, Wu H, Ong S G, Sharma A, Holmstrom A, Chang A C, Coronado M J, Ebert A D, Knowles J W, Telli M L, Witteles R M, Blau H M, Bernstein D, Altman R B and Wu J C. Human induced pluripotent stem cell-derived cardiomyocytes recapitulate the predilection of breast cancer patients to doxorubicin-induced cardiotoxicity. Nat Med. 2016;22:547-56.

34. Magdy T, Schuldt A J T, Wu J C, Bernstein D and Burridge P W. Human Induced Pluripotent Stem Cell (hiPSC)-Derived Cells to Assess Drug Cardiotoxicity: Opportunities and Problems. Annu Rev Pharmacol Toxicol. 2018;58:83-103.

35. Li X, Arslan F, Ren Y, Adav S S, Poh K K, Sorokin V, Lee C N, de Kleijn D, Lim S K and Sze S K. Metabolic adaptation to a disruption in oxygen supply during myocardial ischemia and reperfusion is underpinned by temporal and quantitative changes in the cardiac proteome. J Proteome Res. 2012;11:2331-46.

36. Gharagozloo F, Melendez F J, Hein R A, Shemin R J, DiSesa V J and Cohn L H. The effect of superoxide dismutase and catalase on the extended preservation of the ex vivo heart for transplantation. J Thorac Cardiovasc Surg. 1988;95:1008-13.

37. Land W, Schneeberger H, Schleibner S, Illner W D, Abendroth D, Rutili G, Arfors K E and Messmer K. The beneficial effect of human recombinant superoxide dismutase on acute and chronic rejection events in recipients of cadaveric renal transplants. Transplantation. 1994;57:211-7.

38. Nakagawa K, Koo D D, Davies D R, Gray D W, McLaren A J, Welsh K I, Morris P J and Fuggle S V. Lecithinized superoxide dismutase reduces cold ischemia-induced chronic allograft dysfunction. Kidney Int. 2002;61:1160-9.

39. Mias C, Trouche E, Seguelas M H, Calcagno F, Dignat-George F, Sabatier F, Piercecchi-Marti MD, Daniel L, Bianchi P, Calise D, Bourin P, Parini A and Cussac D. Ex vivo pretreatment with melatonin improves survival, proangiogenic/mitogenic activity, and efficiency of mesenchymal stem cells injected into ischemic kidney. Stem Cells. 2008;26:1749-57.

40. Hu C and Li L. Melatonin plays critical role in mesenchymal stem cell-based regenerative medicine in vitro and in vivo. Stem Cell Res Ther. 2019;10:13.

41. Kotler M, Rodriguez C, Sainz R M, Antolin I and Menendez-Pelaez A. Melatonin increases gene expression for antioxidant enzymes in rat brain cortex. J Pineal Res. 1998;24:83-9.

42. Mayo J C, Sainz R M, Antoli I, Herrera F, Martin V and Rodriguez C. Melatonin regulation of antioxidant enzyme gene expression. Cell Mol Life Sci. 2002;59:1706-13.

43. Katsuda T, Tsuchiya R, Kosaka N, Yoshioka Y, Takagaki K, Oki K, Takeshita F, Sakai Y, Kuroda M and Ochiya T. Human adipose tissue-derived mesenchymal stem cells secrete functional neprilysin-bound exosomes. Sci Rep. 2013;3:1197.

44. Timmers L, Lim S K, Arslan F, Armstrong J S, Hoefer I E, Doevendans P A, Piek J J, El Oakley R M, Choo A, Lee C N, Pasterkamp G and de Kleijn D P. Reduction of myocardial infarct size by human mesenchymal stem cell conditioned medium. Stem cell research. 2007;1:129-37.

45. Timmers L, Lim S K, Hoefer I E, Arslan F, Lai R C, van Oorschot A A, Goumans M J, Strijder C, Sze S K, Choo A, Piek J J, Doevendans P A, Pasterkamp G and de Kleijn D P. Human mesenchymal stem cell-conditioned medium improves cardiac function following myocardial infarction. Stem cell research. 2011;6:206-14.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

What is claimed is:

1. A composition comprising:
(1) superoxide dismutase;
(2) catalase;
(3) vitamin E; and
(4) glutathione.

2. The composition of claim 1, wherein the superoxide dismutase is Cu/Zn superoxide dismutase (SOD1), manganese-dependent superoxide dismutase (SOD2), extracellular superoxide dismutase (SODS), cell surface superoxide dismutase (SOD4), or a combination thereof.

3. The composition of claim 1 or 2, wherein the vitamin E is DL-alpha tocopherol acetate, DL alpha-tocopherol, or a combination thereof.

4. The composition of any one of claims 1-3, wherein the glutathione is reduced.

5. The composition of any one of claims 1-4, wherein the composition further comprises at least one of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

6. The composition of any one of claims 1-4, wherein the composition further comprises biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

7. The composition of claim 5 or 6, wherein the vitamin A is vitamin A acetate.

8. The composition of any one of claims 5-7, wherein the BSA is Fraction V, fatty acid-free BSA.

9. The composition of any one of claims 5-8, wherein the ethanolamine is ethanolamine HCl.

10. The composition of any one of claims 5-9, wherein the L-carnitine is L-carnitine HCl.

11. The composition of any one claims 5-10, wherein the putrescine is putrescine 2HCl.

12. The composition of any one of claims 1-11, wherein the composition further comprises a preservation solution.

13. The composition of claim 12, wherein the preservation solution comprises at least two of the following: sodium, potassium, magnesium, calcium, chloride, phosphate, sulfate, bicarbonate, glucose, histidine, tryptophan, glutamic acid, α-ketoglutarate, lactobionic acid, mannitol, hydroxyethyl starch, raffinose, adenosine, allopurinol, and glutathione.

14. The composition of claim 13, wherein the preservation solution comprises pentafraction, lactone, potassium phosphate monobasic, magnesium sulfate heptahydrate, raffinose pentahydrate, adenosine, allopurinol, glutathione, and potassium hydroxide.

15. The composition of claim 12, wherein the preservation solution comprises University of Wisconsin solution (Viaspan™; Belzer UW® Cold Storage Solution, SPS-1), histidine-tryptophan-ketoglutarate (HTK) solution (CUSTADIOL®), CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1), Marshall citrate solution, or a combination thereof.

16. The composition of claim 15, wherein the preservation solution comprises the University of Wisconsin solution.

17. The composition of any one of claims 1-16, wherein the composition is sterile.

18. The composition of claim 17, wherein the composition is Current Good Manufacturing Practice (cGMP)-compliant.

19. A method of preserving an organ or tissue for transplantation, the method comprising:
contacting the organ or tissue with a composition comprising:
(1) superoxide dismutase;
(2) catalase;
(3) vitamin E; and
(4) glutathione.

20. The method of claim 19, wherein the superoxide dismutase is Cu/Zn superoxide dismutase (SOD1), manganese-dependent superoxide dismutase (SOD2), extracellular superoxide dismutase (SODS), cell surface superoxide dismutase (SOD4), or a combination thereof.

21. The method of claim 19 or 20, wherein the vitamin E is DL-alpha tocopherol acetate, DL alpha-tocopherol, or a combination thereof.

22. The method of any one of claims 19-21, wherein the glutathione is reduced.

23. The method of any one of claims 19-22, wherein the composition further comprises at least one of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

24. The method of any one of claims 19-22, wherein the composition further comprises biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

25. The method of claim 23 or 24, wherein the vitamin A is vitamin A acetate.

26. The method of any one of claims 23-25, wherein the BSA is Fraction V, fatty acid-free BSA.

27. The method of any one of claims 23-26, wherein the ethanolamine is ethanolamine HCl.

28. The method of any one of claims 23-27, wherein the L-carnitine is L-carnitine HCl.

29. The method of any one claims 23-28, wherein the putrescine is putrescine 2HCl.

30. The method of any one of claims 23-29, wherein the composition further comprises a preservation solution.

31. The method of claim 30, wherein the preservation solution comprises at least two of the following: sodium, potassium, magnesium, calcium, chloride, phosphate, sulfate, bicarbonate, glucose, histidine, tryptophan, glutamic acid, α-ketoglutarate, lactobionic acid, mannitol, hydroxyethyl starch, raffinose, adenosine, allopurinol, and glutathione.

32. The method of claim 31, wherein the preservation solution comprises pentafraction, lactone, potassium phosphate monobasic, magnesium sulfate heptahydrate, raffinose pentahydrate, adenosine, allopurinol, glutathione, and potassium hydroxide.

33. The method of claim 30, wherein the preservation solution comprises University of Wisconsin solution (Viaspan™; Belzer UW® Cold Storage Solution, SPS-1), histidine-tryptophan-ketoglutarate (HTK) solution, CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1), Marshall citrate solution, or a combination thereof.

34. The method of claim 33, wherein the preservation solution comprises the University of Wisconsin solution.

35. The method of any one of claims 23-34, wherein the composition is sterile.

36. The method of claim 35, wherein the composition is Current Good Manufacturing Practice (cGMP)-compliant.

37. The method of any one of claims 23-36, wherein the step of contacting comprises immersing, infusing, flushing, or perfusing the organ or tissue with the composition.

38. The method of any one of claims 23-37, wherein the organ or tissue is contacted with the composition for a minimum of 10 seconds to a maximum of 14 days.

39. The method of claim 38, wherein the organ or tissue is contacted with the composition for 30 minutes to 50 hours.

40. The method of claim 39, wherein the organ or tissue is contacted with the composition for 4-8 hours.

41. The method of any one of claims 23-40, wherein the organ or tissue is contacted with the composition at a temperature of 0° C. to 38° C.

42. The method of claim 41, wherein the organ or tissue is contacted with the composition at a temperature of approximately 4° C.

43. The method of claim 41, wherein the organ or tissue is contacted with the composition at a temperature of approximately 15° C.

44. The method of claim 41, wherein the organ or tissue is contacted with the composition at a temperature of approximately 37° C.

45. The method of any one of claims 23-44, further comprising transplanting the preserved organ or tissue into a subject in need thereof.

46. The method of any one of claims 23-45, wherein the organ is selected from the group consisting of heart, kidney, liver, lungs, pancreas, stomach, intestine, uterus, thymus, hand, foot, arm, head, hair follicle, and face.

47. The method of any one of claims 23-45, wherein the tissue is selected from the group consisting of cornea, bone, tendon, muscle, skin, pancreatic islet cells, heart valve, hematopoietic stem cells, mesenchymal stem/stromal cells, keratinocytes and other epithelial cells, nerve, and vascular tissue.

48. The method of claim 46, wherein the organ is a heart.

49. The method of claim 46, wherein the organ is a lung.

50. The method of claim 46, wherein the organ is a kidney.

51. The method of claim 47, wherein the vascular tissue is venous tissue or arterial tissue.

52. The method of any one of claims 45-51, wherein the subject is human.

53. The organ or tissue of any one of claims 46-50, immersed in the composition of any one of claims 1-18.

54. A method of increasing transplant success, the method comprising:
contacting an organ or tissue to be transplanted with a composition comprising:
(1) superoxide dismutase;
(2) catalase;
(3) vitamin E; and
(4) glutathione.

55. The method of claim 51, wherein the increasing transplant success is an increased survival rate.

56. The method of claim 50 or 51, wherein the superoxide dismutase is Cu/Zn superoxide dismutase (SOD1), manganese-dependent superoxide dismutase (SOD2), extracellular superoxide dismutase (SODS), cell surface superoxide dismutase (SOD4), or a combination thereof.

57. The method of any one of claims 50-52, wherein the vitamin E is DL-alpha tocopherol acetate, DL alpha-tocopherol, or a combination thereof.

58. The method of any one of claims 50-57, wherein the glutathione is reduced.

59. The method of any one of claims 50-58, wherein the composition further comprises at least one of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

60. The method of any one of claims 50-58, wherein the composition further comprises biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

61. The method of claim 59 or 60, wherein the vitamin A is vitamin A acetate.

62. The method of any one of claims 59-61, wherein the BSA is Fraction V, fatty acid-free BSA.

63. The method of any one of claims 59-62, wherein the ethanolamine is ethanolamine HCl.

64. The method of any one of claims 59-63, wherein the L-carnitine is L-carnitine HCl.

65. The method of any one claims 59-64, wherein the putrescine is putrescine 2HCl.

66. The method of any one of claims 59-65, wherein the composition further comprises a preservation solution.

67. The method of claim 66, wherein the preservation solution comprises at least two of the following: sodium, potassium, magnesium, calcium, chloride, phosphate, sulfate, bicarbonate, glucose, histidine, tryptophan, glutamic acid, α-ketoglutarate, lactobionic acid, mannitol, hydroxyethyl starch, raffinose, adenosine, allopurinol, and glutathione.

68. The method of claim 67, wherein the preservation solution comprises pentafraction, lactone, potassium phosphate monobasic, magnesium sulfate heptahydrate, raffinose pentahydrate, adenosine, allopurinol, glutathione, and potassium hydroxide.

69. The method of claim 66, wherein the preservation solution comprises University of Wisconsin solution (Viaspan™; Belzer UW® Cold Storage Solution, SPS-1), histidine-tryptophan-ketoglutarate (HTK) solution, CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1), Marshall citrate solution, or a combination thereof.

70. The method of claim 69, wherein the preservation solution comprises the University of Wisconsin solution.

71. The method of any one of claims 50-70, wherein the composition is sterile.

72. The method of claim 71, wherein the composition is Current Good Manufacturing Practice (cGMP)-compliant.

73. The method of any one of claims 50-72, wherein the step of contacting comprises immersing, infusing, flushing, or perfusing the organ or tissue with the composition.

74. The method of any one of claims 50-73, wherein the organ or tissue is contacted with the composition for a minimum of 10 seconds to a maximum of 14 days.

75. The method of claim 74, wherein the organ or tissue is contacted with the composition for 30 minutes to 50 hours.

76. The method of claim 75, wherein the organ or tissue is contacted with the composition for 4-8 hours.

77. The method of any one of claims 50-76, wherein the organ or tissue is contacted with the composition at a temperature of 0° C. to 37° C.

78. The method of claim 77, wherein the organ or tissue is contacted with the composition at a temperature of approximately 4° C.

79. The method of any one of claims 50-78, further comprising transplanting the preserved organ or tissue into a subject in need thereof.

80. The method of any one of claims 50-79, wherein the organ is selected from the group consisting of heart, kidney, liver, lungs, pancreas, stomach, intestine, uterus, thymus, hand, foot, arm, head, hair follicle, and face.

81. The method of any one of claims 50-79, wherein the tissue is selected from the group consisting of cornea, bone, tendon, muscle, skin, pancreatic islet cells, heart valve, hematopoietic stem cells, mesenchymal stem/stromal cells, keratinocytes and other epithelial cells, nerve, and vascular tissue.

82. The method of claim 80, wherein the organ is a heart.

83. The method of claim 80, wherein the organ is a lung.

84. The method of claim 80, wherein the organ is a kidney.

85. The method of claim 81, wherein the vascular tissue is venous tissue or arterial tissue.

86. The method of any one of claims 79-85, wherein the subject is human.

87. A method of prolonging organ or tissue function and/or activity ex vivo, the method comprising:
contacting the organ or tissue with a composition comprising:
(1) superoxide dismutase;
(2) catalase;
(3) vitamin E; and
(4) glutathione.

88. The method of claim 87, wherein the superoxide dismutase is Cu/Zn superoxide dismutase (SOD1), manganese-dependent superoxide dismutase (SOD2), extracellular superoxide dismutase (SODS), cell surface superoxide dismutase (SOD4), or a combination thereof.

89. The method of claim 87 or 88, wherein the vitamin E is DL-alpha tocopherol acetate, DL alpha-tocopherol, or a combination thereof.

90. The method of any one of claims 87-89, wherein the glutathione is reduced.

91. The method of any one of claims 87-90, wherein the composition further comprises at least one of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

92. The method of any one of claims 86-91, wherein the composition further comprises biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

93. The method of claim 91 or 92, wherein the vitamin A is vitamin A acetate.

94. The method of any one of claims 91-93, wherein the BSA is Fraction V, fatty acid-free BSA.

95. The method of any one of claims 91-94, wherein the ethanolamine is ethanolamine HCl.

96. The method of any one of claims 91-95, wherein the L-carnitine is L-carnitine HCl.

97. The method of any one claims 91-96, wherein the putrescine is putrescine 2HCl.

98. The method of any one of claims 91-97, wherein the composition further comprises a preservation solution.

99. The method of claim 98, wherein the preservation solution comprises at least two of the following: sodium, potassium, magnesium, calcium, chloride, phosphate, sulfate, bicarbonate, glucose, histidine, tryptophan, glutamic acid, α-ketoglutarate, lactobionic acid, mannitol, hydroxyethyl starch, raffinose, adenosine, allopurinol, and glutathione.

100. The method of claim 99, wherein the preservation solution comprises pentafraction, lactone, potassium phosphate monobasic, magnesium sulfate heptahydrate, raffinose pentahydrate, adenosine, allopurinol, glutathione, and potassium hydroxide.

101. The method of claim 98, wherein the preservation solution comprises University of Wisconsin solution (Viaspan™; Belzer UW® Cold Storage Solution, SPS-1), histidine-tryptophan-ketoglutarate (HTK) solution, CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1), Marshall citrate solution, or a combination thereof.

102. The method of claim 101, wherein the preservation solution comprises the University of Wisconsin solution.

103. The method of any one of claims 86-102, wherein the composition is sterile.

104. The method of claim 103, wherein the composition is Current Good Manufacturing Practice (cGMP)-compliant.

105. The method of any one of claims 86-103, wherein the step of contacting comprises immersing, infusing, flushing, or perfusing the organ or tissue with the composition.

106. The method of any one of claims 86-105, wherein the organ or tissue is contacted with the composition for a minimum of 10 seconds to a maximum of 14 days.

107. The method of claim 106, wherein the organ or tissue is contacted with the composition for 30 minutes to 50 hours.

108. The method of claim 107, wherein the organ or tissue is contacted with the composition for 4-8 hours.

109. The method of any one of claims 86-108, wherein the organ or tissue is contacted with the composition at a temperature of 0° C. to 37° C.

110. The method of claim 109, wherein the organ or tissue is contacted with the composition at a temperature of approximately 4° C.

111. The method of any one of claims 86-110, further comprising transplanting the preserved organ or tissue into a subject in need thereof.

112. The method of any one of claims 86-111, wherein the organ is selected from the group consisting of heart, kidney, liver, lungs, pancreas, stomach, intestine, uterus, thymus, hand, foot, arm, head, hair follicle, and face.

113. The method of any one of claims 86-111, wherein the tissue is selected from the group consisting of cornea, bone, tendon, muscle, skin, pancreatic islet cells, heart valve, hematopoietic stem cells, mesenchymal stem/stromal cells, keratinocytes and other epithelial cells, nerve, and vascular tissue.

114. The method of claim 112, wherein the organ is a heart.

115. The method of claim 112, wherein the organ is a lung.

116. The method of claim 112, wherein the organ is a kidney.

117. The method of claim 113, wherein the vascular tissue is venous tissue or arterial tissue.

118. The method of any one of claims 111-117, wherein the subject is human.

119. A method of preserving contractile function in contractile tissue, the method comprising, contacting the contractile tissue with a composition comprising:
(1) superoxide dismutase;
(2) catalase;
(3) vitamin E; and
(4) glutathione.

120. The method of claim 119, wherein the superoxide dismutase is Cu/Zn superoxide dismutase (SOD1), manganese-dependent superoxide dismutase (SOD2), extracellular superoxide dismutase (SODS), cell surface superoxide dismutase (SOD4), or a combination thereof.

121. The method of claim 119 or 120, wherein the vitamin E is DL-alpha tocopherol acetate, DL alpha-tocopherol, or a combination thereof.

122. The method of any one of claims 119-121, wherein the glutathione is reduced.

123. The method of any one of claims 119-122, wherein the composition further comprises at least one of the following: biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

124. The method of any one of claims 119-122, wherein the composition further comprises biotin, vitamin A, bovine serum albumin (BSA), human recombinant insulin, human transferrin, corticosterone, D-galactose, ethanolamine, L-carnitine, linoleic acid, linolenic acid, progesterone, putrescine, sodium selenite, and triodo-I-thyronine (T3).

125. The method of claim 123 or 124, wherein the vitamin A is vitamin A acetate.

126. The method of any one of claims 123-125, wherein the BSA is Fraction V, fatty acid-free BSA.

127. The method of any one of claims 123-126, wherein the ethanolamine is ethanolamine

128. The method of any one of claims 123-127, wherein the L-carnitine is L-carnitine HCl.

129. The method of any one claims 123-128, wherein the putrescine is putrescine 2HCl.

130. The method of any one of claims 119-129, wherein the composition further comprises a preservation solution.

131. The method of claim 130, wherein the preservation solution comprises at least two of the following: sodium, potassium, magnesium, calcium, chloride, phosphate, sulfate, bicarbonate, glucose, histidine, tryptophan, glutamic acid, α-ketoglutarate, lactobionic acid, mannitol, hydroxyethyl starch, raffinose, adenosine, allopurinol, and glutathione.

132. The method of claim 131, wherein the preservation solution comprises pentafraction, lactone, potassium phosphate monobasic, magnesium sulfate heptahydrate, raffinose pentahydrate, adenosine, allopurinol, glutathione, and potassium hydroxide.

133. The method of claim 130, wherein the preservation solution comprises University of Wisconsin solution (Viaspan™; Belzer UW® Cold Storage Solution, SPS-1), histidine-tryptophan-ketoglutarate (HTK) solution, CELSIOR® solution, extracellular-type trehalose-containing Kyoto (ET-Kyoto) solution, Institute Georges Lopez, France (IGL-1) solution, Collins solution, Euro-Collins solution, STEEN™ solution, kidney preservation solution (KPS-1), Marshall citrate solution, or a combination thereof.

134. The method of claim 133, wherein the preservation solution comprises the University of Wisconsin solution.

135. The method of any one of claims 119-134, wherein the composition is sterile.

136. The method of claim 135, wherein the composition is Current Good Manufacturing Practice (cGMP)-compliant.

137. The method of any one of claims 119-135, wherein the step of contacting comprises immersing, infusing, flushing, or perfusing the organ or tissue with the composition.

138. The method of any one of claims 119-137, wherein the contractile tissue is contacted with the composition for a minimum of 10 seconds to a maximum of 14 days.

139. The method of claim 138, wherein the contractile tissue is contacted with the composition for 30 minutes to 50 hours.

140. The method of claim 139, wherein the contractile tissue is contacted with the composition for 4-8 hours.

141. The method of any one of claims 119-140, wherein the contractile tissue is contacted with the composition at a temperature of 0° C. to 37° C.

142. The method of claim 141, wherein the contractile tissue is contacted with the composition at a temperature of approximately 4° C.

143. The method of any one of claims 119-142, wherein the contractile tissue comprises cardiac muscle tissue, smooth muscle tissue, skeletal muscle tissue, or a combination thereof.

144. The method of claims 143, wherein the contractile tissue is comprises cardiomyocytes.

145. The method of any one of claims 119-144, wherein the contractile tissue is preserved in vitro, in situ, or ex vivo.

146. Use of a composition to preserve an organ or tissue for transplantation, the use comprising contacting the organ or tissue with the composition of any one of claims 1-18.

147. Use of a composition to increase transplant success, the use comprising contacting an organ or tissue for transplantation with the composition of any one of claims 1-18.

148. Use of a composition to prolong organ or tissue survival ex vivo, the use comprising contacting the organ or tissue with the composition of any one of claims 1-18.

149. Use of a composition to preserve contractile function in contractile tissue, the use comprising contacting the contractile tissue with the composition of any one of claims 1-18.

150. A kit comprising:
(1) a composition of any one of claims 1-11;
(2) a preservation solution;
(2) a container; and
(3) instructions for using the kit.

151. The kit of claim 150, wherein the preservation solution comprises at least two of the following: sodium, potassium, magnesium, calcium, chloride, phosphate, sulfate, bicarbonate, glucose, histidine, tryptophan, glutamic acid, α-ketoglutarate, lactobionic acid, mannitol, hydroxyethyl starch, raffinose, adenosine, allopurinol, and glutathione.

152. The composition of claim 151, wherein the preservation solution comprises pentafraction, lactone, potassium phosphate monobasic, magnesium sulfate heptahydrate, raffinose pentahydrate, adenosine, allopurinol, glutathione, and potassium hydroxide.

153. The kit of any one of claims 150-152, wherein the composition and/or the preservation solution are lyophilized.

154. The kit of claim 153, further comprising an additional container comprising a pharmaceutically acceptable excipient.

155. The kit of any one of claims 150-154, wherein the composition and the preservation solution are in separate containers.

156. The kit of any one of claims 150-155, further comprising at least one catheter.
